(19) United States
(12) Patent Application Publication
(10) Pub. No.: US 2017/0097827 A1
(43) Pub. Date: Apr. 6, 2017

(54) ROLE-SPECIFIC DEVICE BEHAVIOR

(71) Applicant: Microsoft Technology Licensing, LLC, Redmond, WA (US)

(72) Inventors: Andre Wilson Brotto Furtado, Kirkland, WA (US); Robert L. Rounthwaite, Fall City, WA (US); Xiaohan Shi, Sammamish, WA (US); Matthew Richardson, Seattle, WA (US); Ryen White, Woodinville, WA (US); Syed Fahad Allam Shah, Bellevue, WA (US); Shantanu Sharma, New Castle, WA (US)

(21) Appl. No.: 14/876,409

(22) Filed: Oct. 6, 2015

(51) Int. Cl. G06F 9/445

(52) U.S. Cl. CPC G06F 9/445

(57) ABSTRACT

In many computing scenarios, an individual may interact with a device in a variety of roles, such as a student, an intern, and a gamer. While the individual may utilize the device in different ways for each role (e.g., using a particular set of files, applications, websites, and services), the device is not typically informed of the individual's role, and provides generalized device behavior irrespective of the individual's role. Presented herein are techniques for adapting device behavior based on the current role of the individual. Such techniques involve evaluating the individual's role determinants to identify and automatically select the individual's current role; selecting a current role profile, as a subset of the details of the individual profile that are associated with the current role, and excluding details that are not associated with the current role; and adjusting the device behavior according to the current role profile of the individual.

### BACKGROUND

Within the field of computing, many scenarios involve a device utilized by an individual and exhibiting a device behavior. As a first such example, the device may present to the individual a set of files that may be accessed and/or updated by the individual. As a second such example, the device may present to the individual a set of applications that may be utilized by the individual to perform various tasks. As a third such example, the device may present a contact set to the individual, which the individual may utilize to send messages to and/or initiate communication sessions with the contacts. Other such device behaviors include, e.g., presenting various types of alerts to the individual, such as pertaining to calendar appointments and incoming messages; utilizing a set of network devices, such as network connections, printers, and network attached storage (NAS) devices; and interacting with various services on behalf of the individual.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

An individual may utilize a device in the context of various roles, based on the individual's personality, activities, and/or social connections. For example, an individual may, at various times, be a student, a professional, a family member, a friend, and a sports player. In each role, the individual may have a specific set of interests, which may affect the individual's interaction with the device. However, such roles often exist within the individual's mental state, and are not identified or utilized by the device. That is, while the individual may adapt his or her interaction with the device based on the individual's current role, the device may not be informed of the individual's current role, and may not adapt the device behavior of the device accordingly. Rather, the device may interact with the individual in a generalized, role-agnostic manner, irrespective of the current role of the individual.

In order to achieve a role-specific interaction, the individual may choose to configure the device by creating a series of accounts, where each account represents the individual in a different role. For example, the individual may create a different collection of files, applications, contacts, and bookmarks for each of several accounts. The individual may then login to an account associated with a particular role, and may utilize the resources of the device that are associated with the selected account according to the particular role, until the individual concludes the interaction through the role or wishes to utilize a second role. The individual may then logout of the current account and login to another account for the second role.

However, since such devices often regard each account as representing a particular individual, the device may not recognize that two or more accounts represent the same individual in multiple roles. The device may therefore prevent a first account of the individual from accessing resources that are accessible to a second account of the same individual. Such role-based accounts may therefore exhibit a number of disadvantages. As a first such example, the device may undesirably restrict the individual from interaction in the account of a first role while the individual is utilizing the account of a second role; e.g., a message intended for the individual may have been delivered to the first account, but the individual may be logged into the second account and may therefore not receive the message. As a second such example, the individual may have to update the same individual profile details separately for each account; e.g., if the individual moves from a first city to a second city, the individual may have to update the individual's residential information for many different accounts, and accounts that the individual fails to update may utilize incorrect information. As a third such example, the individual may wish to interact with the device concurrently in two roles, but the device may not permit the individual to interact concurrently through two distinct accounts. That is, the device may present two different computing environments for each logged-in account, and the individual may switch between the accounts, but such switching may not fully reflect a concurrent occupation of two or more roles. As a fourth such example, if the individual frequently switches roles, the individual may have to logout and login to new accounts frequently, which may be frustrating for the individual. As a fifth such example, if the individual forgets to switch accounts or accidentally logs into a different account than the individual's intended role, the device may interact with the individual in an unintended role. As a sixth such example, because the device does not recognize multiple accounts as belonging to the same individual, an action to be provided to each individual may be redundantly provided for multiple accounts of the same individual; e.g., a message to be delivered to each individual may be stored for each of five accounts for the same individual, and the individual may then receive five copies of the same message.

Presented herein are techniques for enabling a device to adjust a device behavior while interacting with an individual represented by a variety of roles. In accordance with these techniques, an individual may be represented by an individual profile including the details for at least two roles. Role determinants of the individual may be evaluated to determine, among the at least two roles, a current role of the individual. Among the details of the individual profile, a current role profile may be identified, comprising the subset of details that pertain to the current role and excluding details that do not pertain to the current role. The device may then adjust a device behavior exhibited during interaction with the individual according to the details of the current role profile. In this manner, the device may interact with the individual according to the individual's current role, in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring an interaction of an individual with a device.

FIG. 2 is an illustration of an example scenario featuring an interaction of an individual with a device according to a current role of the individual, in accordance with the techniques presented herein.

FIG. 3 is a component block diagram of an example device implementing an example system that adjusts a device behavior of the device according to a current role of the individual, accordance with the techniques presented herein.

FIG. 4 is a component block diagram of an example server implementing an example system that stores a role set and notifies a device of a current role of an individual in order to assist the device in interacting with the individual, accordance with the techniques presented herein.

FIG. 5 is a flow diagram of an example method of adjusting a device behavior of a device according to a current role of the individual, in accordance with the techniques presented herein.

FIG. 6 is an illustration of an example computer-readable medium comprising processor-executable instructions configured to embody one or more of the provisions set forth herein.

FIG. 7 is an illustration of an example scenario featuring a determination of a current role of an individual, in accordance with the techniques presented herein.

FIG. 8 is an illustration of an example scenario featuring an identification of role determinants respectively associated with the roles of an individual, in accordance with the techniques presented herein.

FIG. 9 is an illustration of an example scenario featuring an individual profile representing an individual according to a set of roles, in accordance with the techniques presented herein.

FIG. 10 is an illustration of an example scenario featuring a role template catalog that generates a role for an individual, in accordance with the techniques presented herein.

FIG. 11 is an illustration of an example scenario featuring a role-specific presentation of actions available within a computing environment, in accordance with the techniques presented herein.

FIG. 12 is an illustration of an example scenario featuring, a role-specific presentation of messages, in accordance with the techniques presented herein.

FIG. 13 is an illustration of an example scenario featuring a role-specific presentation of alerts, in accordance with the techniques presented herein.

FIG. 14 is an illustration of an example scenario featuring a role-specific presentation of content items, in accordance with the techniques presented herein.

FIG. 15 is an illustration of an example scenario featuring a role-specific presentation of a content item, in accordance with the techniques presented herein.

FIG. 16 is an illustration of an example scenario featuring a privacy-centric adaptation of the monitoring of role determinants that is conditioned based on individual consent, in accordance with the techniques presented herein.

FIG. 17 is an illustration of an example scenario featuring the adaptation of a head-mounted display to determine the role of the individual and to adapt the device behavior of the display, in accordance with the techniques presented herein.

FIG. 18 is an illustration of an example computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

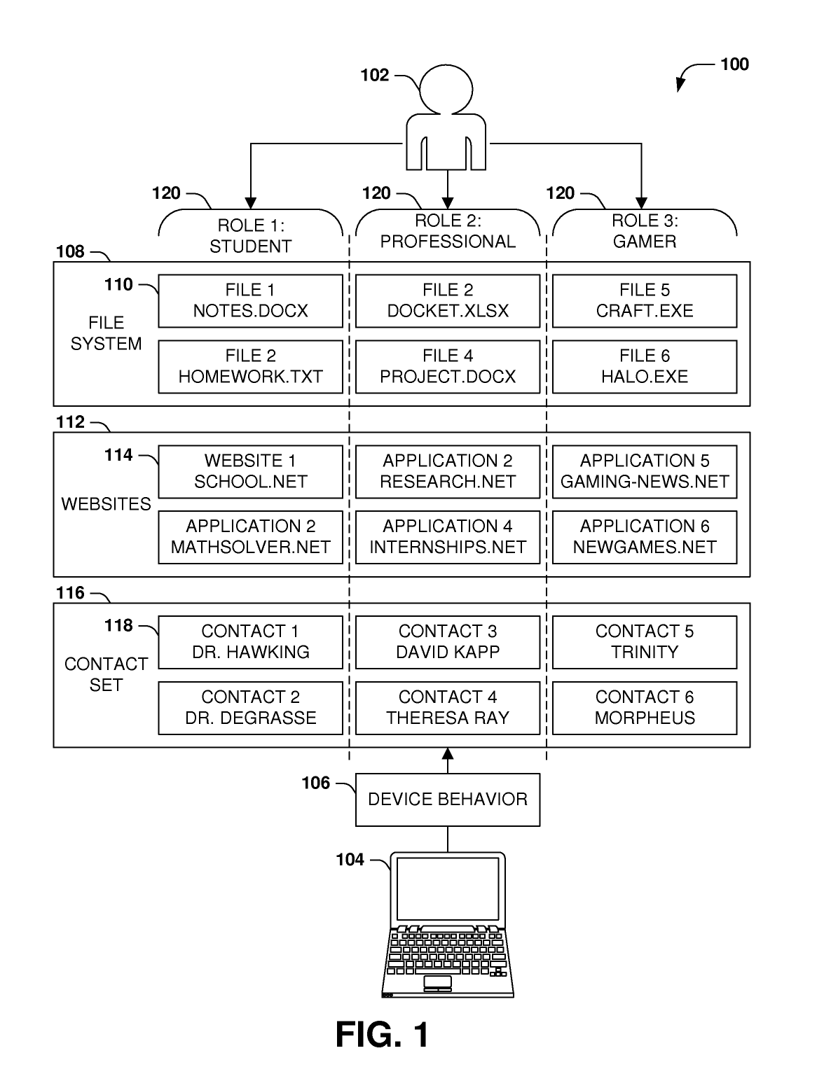

FIG. 1 presents an illustration of an example scenario 100 featuring an individual 102 utilizing a device 104 that exhibits a device behavior 106 in presenting a variety of resources of the computing environment to the individual 102. In this example scenario 100, the device 104 exhibits device behavior 106 that exposes various resources to the individual 102, such as a file system 108 providing a set of files 110, such as documents, applications, media, and data files; a web browser that enables the individual 102 to access a variety of websites 114 over a local area network (LAN) or wide area network (WAN) such as the internet; and a contact set 116 comprising a set of contacts 118 with whom the individual 102 may choose to interact. The device behavior 106 of the device 104 may vary among the individuals 102 who interact with the device 104; e.g., a first individual 102 using a first account, such as an administrative account, may be granted unlimited permissions to access the files 110 and other resources of the device 104, while a second individual 102 and a third individual 102 may respectively hold permissions to access personal files 110 within a personalized (“home”) folder. Such individuals 102 may login to the device 104 concurrently and/or consecutively, and the device 104 may enforce the device behavior 106 provided to each individual 102.

More specifically, a particular individual 102 may interact with the device 104 in accordance with a role 120 that is currently occupied by the individual 102. For example, the individual 102 may, by turns, occupy a first role 120 of a student with a particular school; a second role 120 of a professional, such as an intern with a particular company or organization; and a third role 130 of a gamer. Other such roles 120 of the individual 102 may include, e.g., a friend or family member in a social network; a member of a community, such as a political, religious, or special interest group; and a customer or patron of a particular service. In the respective roles 120, the individual 102 may interact with the device 104 in a particular manner. As a first such example, in a student role 120, the individual may access files 110 pertinent to the individual's academic curriculum, such as class notes and homework assignments; may access websites 114 that relate to students, such as a student community network and a mathematics tool; and may communicate with contacts 118 through the individual's school, such as the individual's instructors and classmates. As a second such example, in a professional role 120, the individual 102 may access files 110 that relate to the individual's professional responsibilities, such as project resources; may access websites 114 that relate to internships, such as a professional research network and an internships informational website 114; and may access contacts 118 who relate to the individual's professional interests, such as the individual's professional colleagues. As a third such example, in a gaming role 120, the individual 102 may access files 110 that provide various games on the device 104; may access websites 114 associated with games, such as gaming news and review websites 114; and may communicate with contacts 118 who play games with the individual 102, such as the individual's teammates.

In this manner, the device 104 may enable the individual 102 to access the resources of the computing environment in order to achieve any tasks of interest to the individual 102. However, a significant factor in this example scenario 100 involves the inflexibility of the device 104 to adapt the device behavior 106 to the particular role 120 of the individual 102. For example, irrespective of the role 120 of the individual 102, the device 104 may present to the individual 102 the same set of files 110, websites 114, contacts 118, and other resources. Accordingly, in order to interact with the device 104 according to a particular role 120, the individual 102 may have to adapt his or her behaviors and interaction. As a first example, among a set of files 110 in the file system 108, the individual 102 may have to distinguish mentally between the files 110 that do pertain to the particular role 120 from those that do not, and may have to focus upon the former files 110 while disregarding the latter files 110. As a second example, while interacting with various websites 114, the individual 102 may have to limit himself or herself to the websites 114 that are associated with the role 120, and may have to remember to interact with such websites 114 using the credentials of the particular role 120. As a third example, the individual 102 may have to adapt applications and task processes to relate to the particular role 120 of the individual 102, e.g., reconfiguring a particular application to suit the tasks and considerations of the particular role 120.

Instead, an individual 102 may adapt the device 104 to reflect different device behavior 106 for respective roles 120 by creating on the device 106 a set of accounts, each representing a role 120. Each account may be created with permissions to a specific set of files 110, applications, websites 114, and contacts 118, as well as other resources, such as application configuration, task flows, and stored credentials. In order to interact with the device 104 in a particular role 120, the individual 102 may login to the associated account, and may interact with the device 104 according to the device behavior 106 reflecting the details of the logged-in account. When the individual's interaction with the role 120 is complete, the individual 102 may logout of the associated account, and may then login to a second account that is associated with a second role 120.

However, in many such devices 104, the respective accounts are intended not to reflect different roles 120 utilized by the same individual 102, but, rather, distinct individuals 102. To this end, each account is designed to provide a discrete set of resources for each individual 102, and to isolate the resources of one individual 102 from access by other accounts managed by other individuals 102 (e.g., a private set of files, application permissions, task flows, bookmark and contact sets, and credentials). That is, the use of accounts may not be well-suited to achieve the role-specific adaptation of device behavior 106 according to each of two or more roles 120 of the same individual 102.

This distinction may result in a variety of disadvantages may arise from the representation of the roles 120 of the individual 102 according to at least two accounts. As a first such example, the device 104 may restrict the individual 102 from interaction in the account of a first role 120 while the individual 102 is logged into the account of a second role 120. For example, the individual 102 may engage in a transaction with a commercial service in a first account, and the service may subsequently deliver a message to the first account relating to the transaction. However, the individual 102 may have logged out of the first account on the device 104 and logged into a second account, and may therefore not receive the message from the service until logging into the first account again.

As a second such example, the individual 102 may be frustrated at having to generate and maintain a variety of accounts on the device 104 for the respective roles 120. For example, if each account utilizes a unique username and password combination, the individual 102 may have to generate and remember a variety of such combinations, and may have difficulty remembering which combination is associated with each account, and the role 120 that each account represents. Moreover, the individual 102 may provide an update of a first account to alter the device behavior 106 to be exhibited by the device 104 on behalf of a first role 120 (e.g., updating the city of residence of one account to alter the time zone utilized by the device 104), but may fail to update the individual profile details 206 of a second account of the device 104, thereby leading to incorrect, unexpected, and/or inconsistent device behavior 106 while the individual 102 is logged into the second account for the second role 120. And while many devices 104 may enable the individual 102 to specify that a first resource associated with a first account 120 may be shared with a second account 120, such sharing may have to be specified by the individual 102 for every resource of the device 104. Moreover, if the individual 102 utilizes a significant number of roles 120, achieving consistent configuration of an update to the device behavior 106 may involve applying the update to each of a potentially large number of accounts on the device 104.

As a third such example, the individual 102 may wish to interact with the device 104 concurrently in two roles, such as concurrently communicating through the social network concurrently with a first contact in a student role and a second contact in a social role. However, the device 104 may only permit the individual 102 to login to one account at a time, particularly if the individual 102 is utilizing the account through a stationary interface featuring a single set of input and output devices. Even if the device 104 permits two or more accounts to be logged in concurrently, each account is typically separated from the other; e.g., a first computing environment for the first account is presented on a first device separately from a second computing environment for the second account, and the computing environments are mutually isolated, which conflicts with the intent of the individual 102 to interact through both roles 120 concurrently (e.g., as a superset of both accounts, rather than separate instances). Instead, the individual 102 may have to access the device 104 alternatively between the respective accounts in order to keep the device behavior 106 of the device 104 consistent with the dynamic roles 120 of the individual 102. Moreover, if the individual 102 frequently switches roles 120, the individual 102 may have to logout of a current account and login to a different account 104 frequently, which may be frustrating for the individual 102.

As a fourth such example, the individual 102 may wish to access the device 104 through a first account that is associated with a first role 120, but may accidentally login to a second account that is associated with the second role 120, and/or may forget to switch from the second account to the first account. Accordingly, the device 104 may interact with the individual 102 through the wrong role 120 that is associated with the logged-in account. For example, the individual 102 may wish to perform a task on the device 104 involving the device behavior 106 that is associated with a first account for a first role 120, but if the individual 102 fails to logout of a second account associated with a second role and to login to the first account, the device 104 may inadvertently perform the task on behalf of the second role 120 rather than the first role 120.

As a fifth such example, because the device 104 is not configured to recognize that multiple accounts belong to the same individual 102, the device 104 that seeks to perform an action for each individual 102 may redundantly perform the action for each of multiple accounts for the same individual 102. For example, the device 104 may endeavor to deliver one copy of a particular message about the device 104 to each individual 102 who utilizes the device 104, but may inadvertently store four copies of the message in each of the four accounts belonging to the same individual 102, thus inefficiently utilizing the resources of the device 104. Moreover, the individual 102 may successively receive four copies of the same message upon logging into each of the accounts. These and other disadvantages may arise from the interaction of the individual 102 with the device 104 in various roles 120 through respective accounts.

### B. Presented Techniques

Presented herein are techniques for configuring a device 120 to interact with an individual 102 in a variety of roles 120, and to adjust the device behavior 106 of the device 104 in view of the current role 212 of the individual 102.

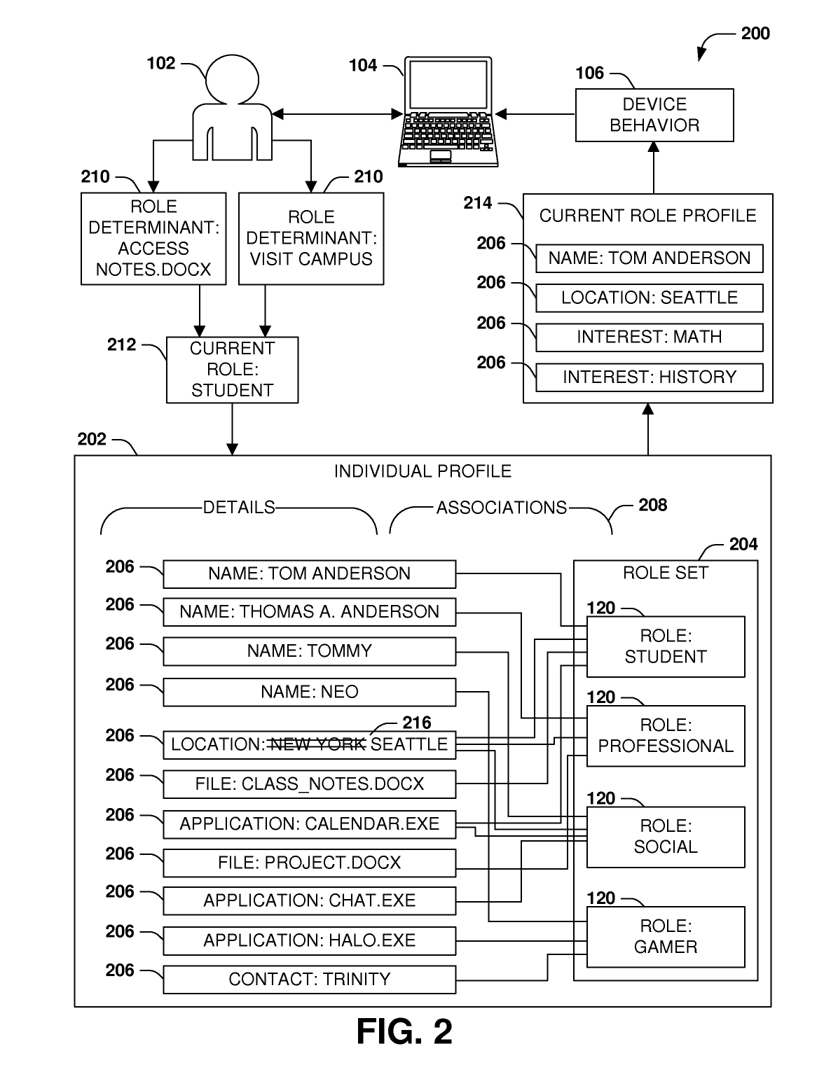

FIG. 2 presents an illustration of an example scenario 200 featuring an individual 102 who interacts with a device 104 in the context of two or more roles 120 of a role set 204, such as a student role, a professional role, a social role, and a gaming role. In this example scenario 200, the individual 102 is represented using an individual profile 202, comprising the individual profile details 206 of each of the roles 120 of the role set 204. For example, individual profile details 206 of the individual profile 202 include various names that the individual 102 may use in different roles 120, such as a casual name; a formal name; a familial name; and a gaming pseudonym. The individual profile details 206 of the individual profile 202 also include applications that may be accessible to the individual 102 in one or more roles 120; files 110 and/or folders that may be principally utilized by the individual 102 in one or more roles 120; and contacts with whom the individual 102 may interact in the context of one or more roles 120. The individual profile 202 in this example scenario 200 also stores a set of associations 208 between the respective individual profile details 206 and the roles 120 that are associated with the individual profile detail 206.

Among the roles 120 of the role set 204, a current role 212 of the individual 102 may be designated as a role 120 in which the individual 102 currently wishes to interact with the device 104. An evaluation may be performed of one or more role determinants 210 of the individual 102 that may enable a determination of the intent of the individual 102 to interact with the device 104 in the context of the current role 212. Role determinants may comprise (e.g., actions performed by the user, such as a gesture, expression, or interaction with a device); details about the user, such as the user's current location or attire; and details about other users or devices that are associated with the user (e.g., the presence of other individuals who have an association with the user, such as the user's colleagues). A first role determinant 210 may be detected that the individual 102 is currently at a particular location, such as visiting the campus of the individual's school; and a second role determinant 210 may be detected that the individual 102 is currently accessing a file that comprises the individual's class notes. These role determinants 210 may indicate that the individual 102 is currently participating in the current role 212 of a student.

Responsive to identifying the current role 212 of the individual 102, a current role profile 214 of the individual 102 may be generated as a subset of the individual profile details 206 of the individual profile 202. For example, responsive to detecting that the individual 102 is currently interacting in the current role 212 of a student, the individual profile details 206 having an association 208 with the student role 120 may be selected for inclusion in the current role profile 214, and the individual profile details 206 that do not have an association 208 with the student role 120 may be excluded from the current role profile 214.

Having selected the current role profile 214, the device 104 may select a device behavior 106 according to the current role profile 214. As a first example, while representing the individual 102, the device 104 may utilize the name of the individual 102 that is associated with the current role 212 of the individual 102 (e.g., automatically adding the selected name of the individual 102 to created files, and/or using the selected name in communication with other individuals, such as automatically signing email messages). As a second example, the device 104 may principally present a specific set of resources, such as files, applications, messages, alerts, media objects, tasks, contacts, websites, and credentials) that are associated with the current role 212, without necessarily restricting the individual 102 from accessing other resources of the device 104 that are associated with other roles 120. As a third example, the device 104 may interact with various services using the set of individual profile details 206 associated with the current role 212 of the individual 102. In these and a variety of other ways, the device 104 may adapt the device behavior 106 of the device 104 to interact with the individual 102 in accordance with the current role 212 of the individual 102, in accordance with the techniques presented herein.

### C. Technical Effects

The use of the techniques presented herein to adapt the device behavior 106 of a device 104 according to the current role 212 of an individual 102 may result in a variety of technical effects.

As a first example of a technical effect that may be achievable by the techniques presented herein, the representation of the individual 102 through an individual profile 202 including the individual profile details 206 for at least two roles 120 of the individual 102 may enable the device 104 to adapt its device behavior 106 to the current role 212 of the individual 102, and may reduce the degree to which the individual 102 has to adapt his or her mental processes to utilize the device 104 in a role-specific manner. As a first such example, when examining a message list such as an email mailbox, rather than having the individual 102 visually sort through all of the received messages to find those that pertain to the current role 212 of the individual 102, the device 104 may constrain the presented messages to the subset that pertain to the current role 212 of the individual 102 (e.g., messages sent to the individual 102 by a contact 118 who is associated with the current role 212 of the individual 102). As a second such example, when the individual 102 seeks to instantiate an application, the device 104 may limit an application menu to a subset of applications that relate to the current role 212 of the individual 102, thereby enabling the individual 102 to locate applications of interest faster.

As a second example of a technical effect that may be achievable by the techniques presented herein, the representation of the individual 102 through an individual profile 202 including the individual profile details 206 for at least two roles 120 of the individual 102 may enable the device 104 to adapt its device behavior 106 to the current role 212 of the individual 102, without the individual 102 having to establish multiple accounts, and without isolating a first account of the individual 102 from a second account of the same individual 102. For example, the device 104 may understand that the same individual 102 is interacting with the device 104 at different times through a first role 120 and a second role 120, and may refrain from artificially isolating the details of each set of interactions from the individual 102. Instead, the device 104 may impose a soft threshold on the set of resources presented to the individual 102 by principally presenting the resources that are associated with the selected role 212, but also allowing the individual 102 to access the resources associated with other roles 120 of the individual 102, rather than imposing a strict isolation as between accounts representing distinct individuals 102. As a first such example, automatic adaptation to the current role 212 of the individual 102 may allow the individual 102 to transition a current computing session seamlessly according to the selection of different current roles 212, rather than having to suspend a first computing session for a first role 120, select or initiate a second computing session for a second role 120, and then reopen applications or documents that the individual 102 was utilizing in the first role 120). As a second such example, if the individual 102 initiates transactions with the device 104 through a variety of roles 120, the device 104 may first present to the individual 102 only the transactions that are associated with the current role 212 of the individual 102, but may also offer to present a complete set of transactions through other roles 120 of the individual 102.

As a third example of a technical effect that may be achievable by the techniques presented herein, the individual account details 206 of the individual profile 202 may be more easily managed by the individual 102 for a set of roles 120 than a discrete set of individual profile details 206 for a plurality of accounts respectively having an isolated individual profile 202. As a first such example, the individual 102 does not have to create multiple accounts respectively utilizing a unique username and password combination. As a second such example, the individual 102 does not have to enter and maintain the individual profile details 206 redundantly for several accounts. As a third such example, an update 216 to an individual profile detail 206, such as the individual's current residential location, may be specified by the individual 102 only once for the individual profile 202, and the update 216 may be reflected concurrently to each of the roles 120 that are associated with the updated individual profile detail 206. Such individual profiles 202 may therefore reduce the incidence of stale and/or conflicting individual profile details 206 among the respective roles 120 of the individual 102.

As a fourth example of a technical effect that may be achievable by the techniques presented herein, the automatic selection of the current role 212 based on the role determinants 210 of the individual 102 may alleviate the individual 102 of affirmatively logging out of a first account 104 and logging into a second account 104 in order to interact with the device 104 through a different role 120. Rather, the individual 102 may utilize one username and password combination for the account of the individual 102. The individual 102 may then switch among roles 120 represented within the account and individual profile 202 of the individual 102 without having to enter role-specific login credentials, but simply by performing actions that are naturally associated with a current role 212, such as traveling to a particular location, interacting with a particular device or resource, or communicating with a particular contact. The device 104 may automatically respond by evaluating the role determinants 210 to select a current role 212 that is indicated by the role determinants 210 and accordingly adjusting the device behavior 106 according to the current role profile 214 of the current role 212, thereby providing a more adept and less cumbersome user experience for the individual 102. Such automated adaptation may reduce the necessity of repeatedly logging out and into multiple user profiles during a computing session, which may reduce avoidable security risks, such as eavesdropping on entered login credentials. Moreover, such automatic selection of the current role 212 may reduce the incidence of the individual 102 inadvertently interacting with the device 104 in an unintended role.

As a fifth example of a technical effect that may be achievable by the techniques presented herein, the interaction of the individual 102 with the device 104 according to an automated selection of the current role profile 214 for the current role 212 may economize the resources of the device 104 by reducing the creation and/or maintenance of multiple accounts 104 for the same individual 102. As a first such example, rather than storing four complete and distinct accounts 104 for the same individual 102, the device 104 may store only one representation of the individual 102. Such an architecture may therefore utilize the individual profile details 206 of the current role profile 214 utilized by the device 104. As a second such example, in order to interact with the set of individuals 102 who utilizes the device 104, the device 104 may interact with each such individual 102 (e.g., delivering a particular message to the individual 102 only once), rather than redundantly interacting with each of the several accounts 104 representing the same individual 102. Such de-duplication of representations of the individual 102 may therefore facilitate the economy of the resources of the device 104 (e.g., enabling the device 104 to scale to serve a larger number of individuals 102 for a particular set of device hardware), and/or may reduce redundancy in the user experience of the individual 102 (e.g., providing a particular message to the individual 102 only once, instead of once for each account 104 utilized by the individual). As a second such example, resources of the device 104 (e.g., applications and data stores) that pertain to multiple roles 120 may be shared among such roles 120, rather than compelling the individual 102 to provide duplicate sets of such resources for different accounts that represent the different roles 120 of the individual 102.

As a sixth example of a technical effect that may be achievable by the techniques presented herein, the adaptation of the behavior of the device 104 to the current role 212 of the individual 102 may enable efficiency in the operation of the device 104. For example, the device 104 may be able to identify functionality that is not relevant to the current role 212, and may disable such functionality (e.g., suspending background applications and turning off device components that are not in use), thereby conserving the expenditure of computing resources, such as memory, processor throughput, network capacity, and display space, for functionality that services the current role 212 of the individual 102. As one such example, the device 104 may complete computationally intensive tasks faster by focusing computational power on the tasks that relate to the current role 212 of the individual 102. As a second such example, a battery-powered device 104 may conserve limited stored energy for the tasks that relate to the current role 212 of the individual 102, and may therefore provide extended battery life. These and other technical effects may be achievable through the configuration of the device 104 to adjust various device behaviors 106 based on the current role profile 214 of the current role 212 of the individual 102 in accordance with the techniques presented herein.

### D. Example Embodiments

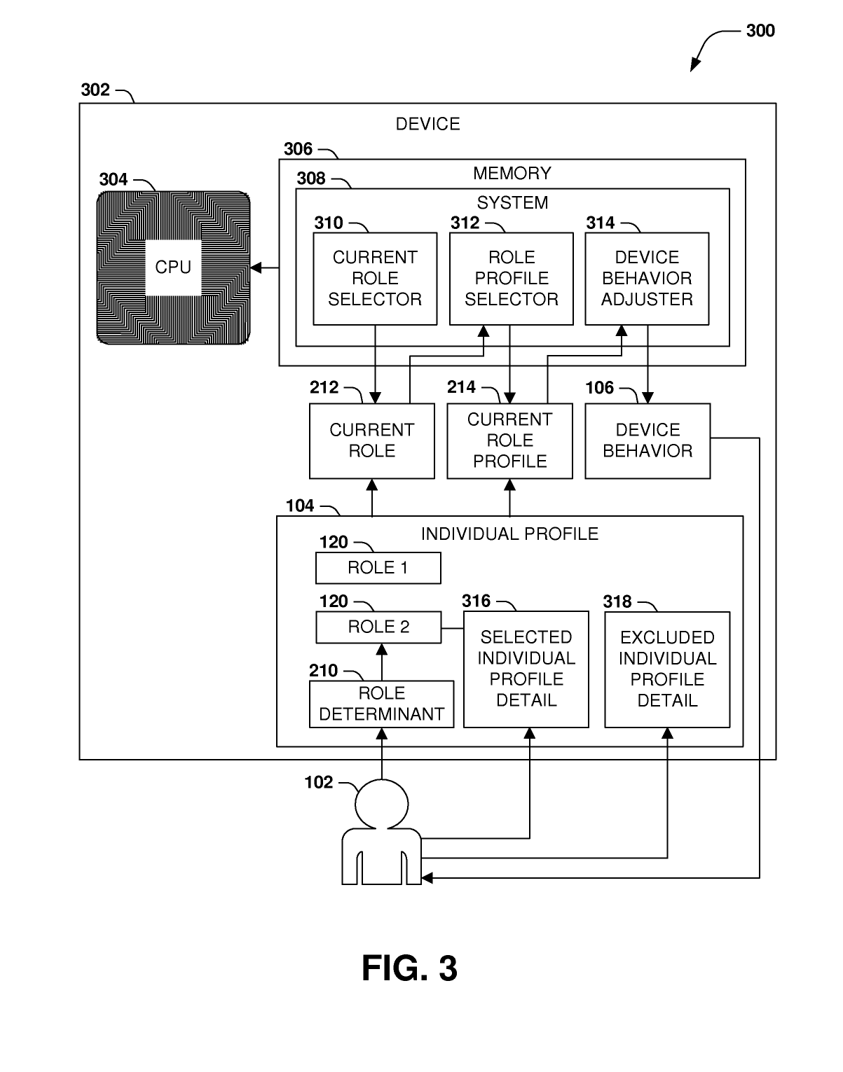

FIG. 3 presents a first example embodiment of the techniques presented herein, illustrated as an example system 308 that causes an example device 302 featuring a processor 304 and a memory 306 to adjust a device behavior 106 according to a current role 212 of an individual 102. The example system 308 may be implemented, e.g., as a set of components respectively comprising a set of instructions stored in the memory 306 of the device 302, where the instructions of respective components, when executed on the processor 304, cause the device 302 to operate in accordance with the techniques presented herein.

The example system 308 includes a current role selector 310, which, responsive to detecting a role determinant 210 of the individual 102, selects, among at least two roles 120 of the individual 102, a current role 212 that is associated with the role determinant 210. The example system 308 also includes a role profile selector 412, which selects, from the individual profile 202, a current role profile 214, comprising at least one selected individual profile detail 316 that is associated with the current role 212, and excluding at least one individual profile detail 316 that is not associated with the current role 212. The example system 308 also includes a device behavior adjuster 314, which adjusts the device behavior 106 of the device 302 according to the current role profile 214 of the individual 102. In this manner, the example system 308 enables the device 302 to adjust the device behavior 106 according to the current role 212 to the individual 102 in accordance with the techniques presented herein.

FIG. 3 also presents a second example embodiment of the techniques presented herein, illustrated as an example device 302 that adjusts a device behavior 106 according to a current role 212 of an individual 102. The example device 302 that comprises an embodiment of the techniques presented herein includes a processor 304, and a memory 306 storing instructions that, when executed by the processor 304, provide an example system 308 of elements that interoperate to achieve the adjustment of the device behavior 106 in accordance with the techniques presented herein. The example system 308 includes a current role selector 310, which, responsive to detecting a role determinant 210 of the individual 102, selects, among at least two roles 120 of the individual 102, a current role 212 that is associated with the role determinant 210. The example system 308 also includes a role profile selector 412, which selects, from the individual profile 202, a current role profile 214, comprising at least one selected individual profile detail 316 that is associated with the current role 212, and excluding at least one individual profile detail 316 that is not associated with the current role 212. The example system 308 also includes a device behavior adjuster 314, which adjusts the device behavior 106 of the device 302 according to the current role profile 214 of the individual 102. In this manner, the example device 302 adjusts its device behavior 106 according to the current role 212 to the individual 102 in accordance with the techniques presented herein.

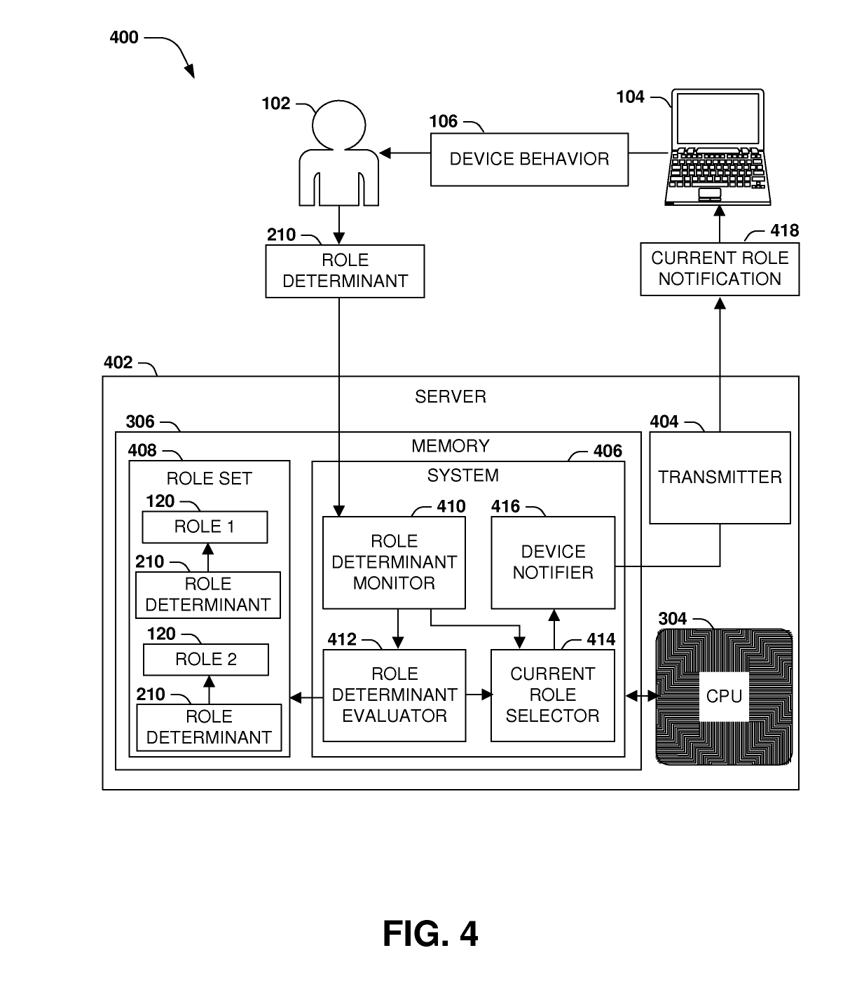

FIG. 4 presents an illustration of an example scenario 400 featuring a third example embodiment of the techniques presented herein, involving an example system 406 that stores a role set 408, and informs a device 104 of an individual 102 about a current role of the individual 102, in order to assist the device in adjusting a device behavior 106 according to the current role of the individual 102, in accordance with the techniques presented herein. In this example scenario 400, the server 402 comprises a memory 306 storing a role set 408 including a set of roles 120 that the individual 102 may exhibit, and where each role 120 is associated with one or more role determinants 210 that are indicative that the individual 102 is operating in the role 120. The server 402 also comprises a processor 304 and a transmitter 404, such as a cellular communicator or a short-range wireless local area network (WLAN) adapter, that enables the server 402 to communicate with a device 104 of the individual 102.

The memory 306 of the server 402 also stores instructions that, when executed by the processor 304, provide an example system 406 that causes the server 402 to assist the device 104 in interacting with the individual 102 in accordance with the techniques presented herein. In particular, the system 406 comprises a role determinant monitor 410, which receives indicators of at least one role determinant 210 that indicates a selected role 120 of the individual 102. For example, the role determinants 210 may include, e.g., an indication of an action performed by the individual 102; a geolocation, such as a set of location coordinates, of the individual 102; a notification of an interaction of the individual 102 with the device 104; and/or the identity of a second individual who is in the vicinity of the individual 102 and/or who is communicating with the individual 102. The example system 406 further comprises a role determinant evaluator 412, which, responsive to the role determinant monitor 410 receiving the at least one role determinant 210, compares the at least one role determinant 210 with the at least two roles 120 of the role set 408 to identify the selected role 120 that is indicated by the at least one role determinant 210, and stores, in the role set 408, an association between the selected role 120 of the individual 102 and the at least one role determinant 210 indicative of the selected role 120. The example system 406 further comprises a current role selector 414, which, responsive to the role determinant monitor 410 receiving a current role determinant 210 that currently describes the individual 102, selects, among the at least two roles 120 of the role set 408, a current role 212 that is associated with the current role determinant 210 that currently describes the individual 102. The example system 406 further comprises a device notifier 416, which invokes the transmitter 404 to transmit to the device 104 a current role notification 418 of the current role 212 of the individual 102, in order to assist the device 104 in adapting a device behavior 106 of an interaction of the device 104 with the individual 102 according to the current role 212. In this manner, the example system 406 of the example server 402 assists the device 104 in adapting a device behavior 106 according to the current role 212 of the individual 102, in accordance with the techniques presented herein.

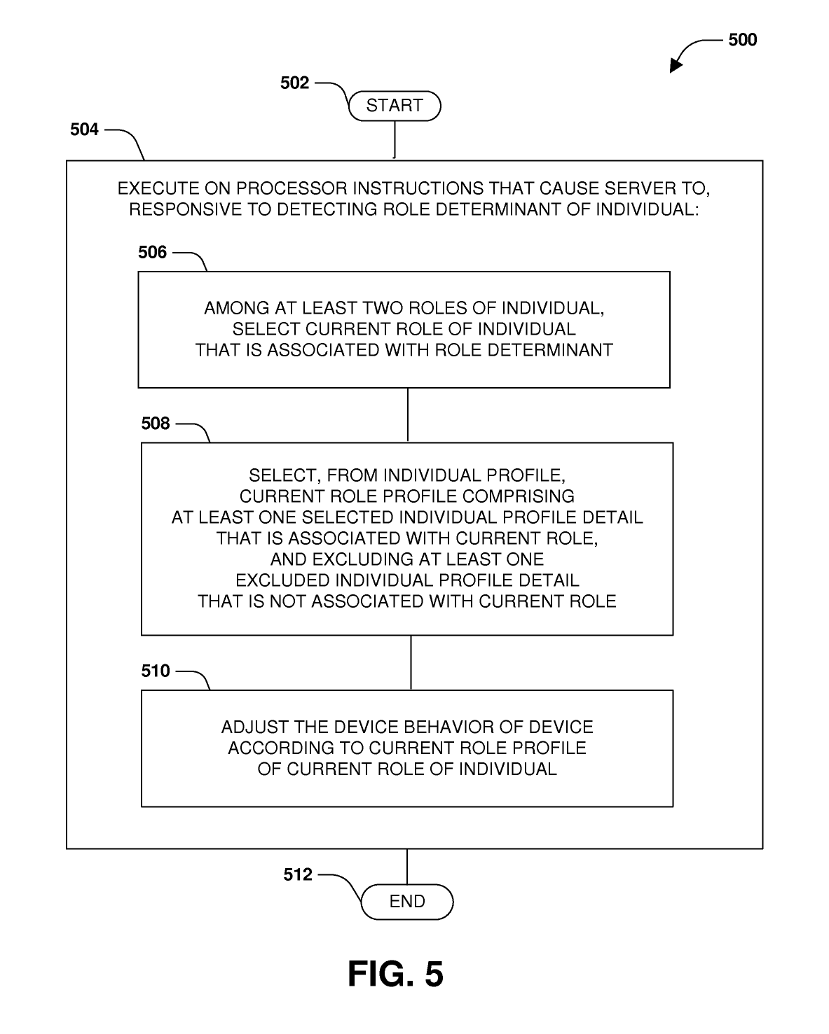

FIG. 5 presents a fourth example embodiment of the techniques presented herein, illustrated as an example method 500 of configuring a device 104 to adjust a device behavior 106 while interacting with an individual 102 having an individual profile 202. The example method 500 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 500 begins at 502 and involves executing 504 the instructions on a processor of the device. Specifically, executing 504 the instructions on the processor causes the device to, among at least two roles 120 of the individual 102, select 506 a current role 212 of the individual 102 that is associated with the role determinant 210. Executing 504 the instructions on the processor further causes the device to select 508, from the individual profile 202, a current role profile 214 comprising at least one selected individual profile detail 206 that is associated with the current role 212, and excluding at least one individual profile detail 206 that is not associated with the current role 212. Executing 504 the instructions on the processor further causes the device to adjust 410 the device behavior 106 of the device 104 according to the current role profile 214 of the current role 212 of the individual 102. In this manner, the instructions cause the device 104 to adjust the device behavior 104 according to the current role 212 of the individual 102 in accordance with the techniques presented herein, and so the example method 500 ends at 512.

A fifth example embodiment of the techniques presented herein involves a computer-readable medium comprising processor-executable instructions configured to apply the techniques presented herein. Such computer-readable media may include (as one distinct subset of computer-readable media) various types of communications media, such as signals that may propagate through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encode a set of computer-readable instructions that, when executed by a processor of a device, cause the device to implement the techniques presented herein. Such computer-readable media may also include (as a class of technologies that excludes communications media) computer-readable memory devices, such as a memory semiconductor (e.g., a semiconductor utilizing static random access memory (SRAM), dynamic random access memory (DRAM), synchronous dynamic random access memory (SDRAM) technologies), a platter of a hard disk drive or solid-state memory device, a flash memory device, or a magnetic or optical disc (such as a CD-R, DVD-R, or floppy disc), which encode a set of computer-readable instructions that, when executed by a processor of a device, cause the device to implement the techniques presented herein.

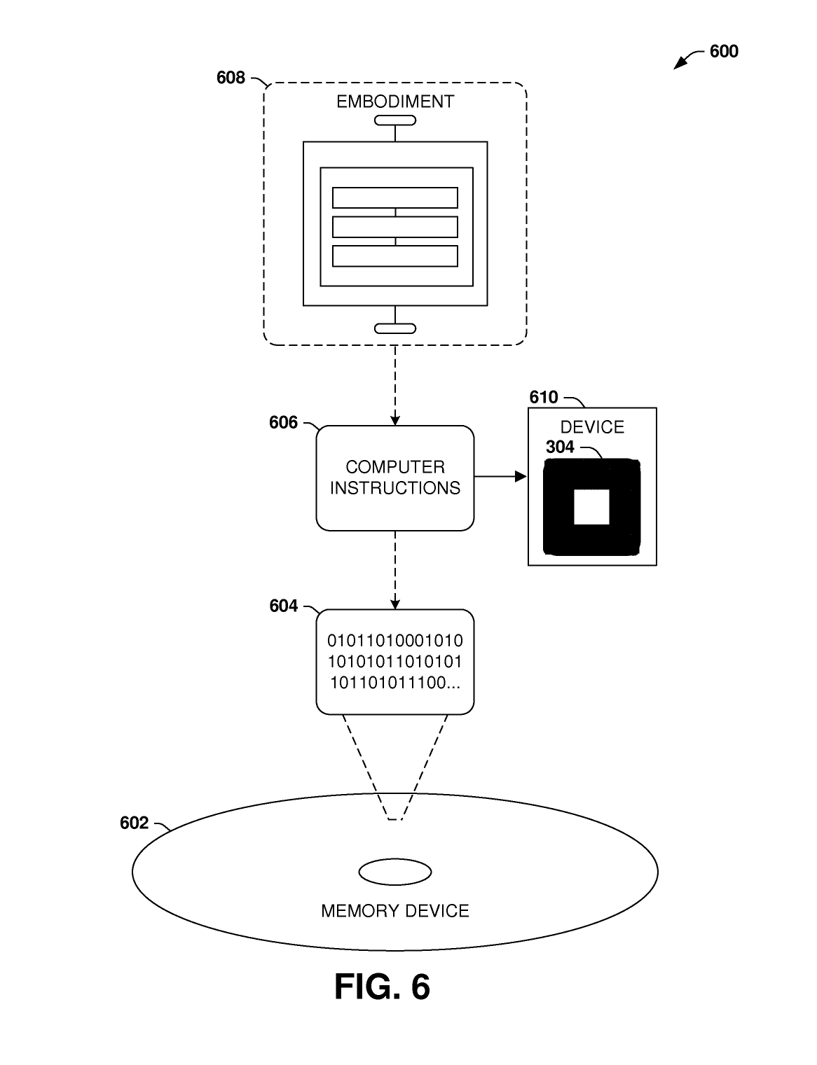

FIG. 6 presents an illustration of an example scenario 600 including a computer-readable memory device 602 (e.g., a CD-R, DVD-R, or a platter of a hard disk drive), on which is encoded computer-readable data 604. This computer-readable data 604 in turn comprises a set of computer instructions 606 that, when executed on a processor 304 of a device 610, cause the device 610 to operate according to the principles set forth herein. In a first such embodiment, the processor-executable instructions 606 may provide a system that causes a device to adjust a device behavior 106 according to the current role 212 of the individual 102, such as the example system 308 in the example scenario 300 of FIG. 3. In a second such embodiment, the processor-executable instructions 606 may be part of a device that adjusts a device behavior 106 according to the current role 212 of the individual 102, such as the example device 302 in the example scenario 300 of FIG. 3. In a third such embodiment, the processor-executable instructions 606 may be part of a server that stores an individual profile of an individual 102 and informs a device of a current role 212 of the individual 102 in order to enable the device 102 to adjust a device behavior 106 according to the current role 212, such as the example server in the example scenario 400 of FIG. 4. In a fourth such embodiment, the processor-executable instructions 606 may cause the device 610 to perform a method of adjusting a device behavior 106 of the device 610 according to a current role 212 of the individual 102, such as the example method 500 of FIG. 5. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example device 302 of FIG. 3; the example system 308 of FIG. 3; the example server of FIG. 4; the example method 500 of FIG. 5; and the example memory device 602 of FIG. 6) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices 302, such as workstations, laptops, tablets, mobile phones, game consoles, portable gaming devices, portable or non-portable media players, media display devices such as televisions, appliances, home automation devices, computing components integrated with a wearable device integrating such as an eyepiece or a watch, and supervisory control and data acquisition (SCADA) devices.

As a second variation of this first aspect, various architectures may be utilized to implement the techniques presented herein. As a first such example, the device 302 may store the individual profile 202; detect the role determinants 210; determine a current role 212 of the individual 102 that is associated with the role determinants 210; select the current role profile 214 from the individual profile 202 according to the current role 212; and adjust the device behavior 106 of the device 104 according to the current role profile 214. As a second such example, various elements of the disclosed techniques may be distributed over two or more devices 104, such as a user device 104 that detects the role determinant 210 and determines the current role 212 of the individual 102 and adjusts the device behavior 106 of the device 104 according to the current role profile 214, and a first server storing the individual profile 202 that generates the current role profile 214 from the individual profile 202 according to the current role 212. As a third such example, one or more devices 104 implementing the techniques presented herein may be informed by other devices 104; e.g., a mobile device 104 implementing the techniques presented herein may identify a role determinant 210 as a gesture that is detected by a wearable device 104 such as a wristwatch, and may provide the current role profile 214 to a third device 104 that adjusts its device behavior 106 according to the current role profile 214 representing the current role 212 of the individual 102.

As a third variation of this first aspect, the techniques presented herein may be utilized with various types of individual profiles 202, including social networking and social media profiles; academic and/or professional individual profiles; gaming profiles provided for a gaming service; media profiles for individuals 102 producing and/or consuming various types of media; individual behavior profiles of devices that monitor the behavior of the individual 102; governmental profiles of the civic details of various individuals 102; financial profiles of the financial status of various individuals 102; and commercial profiles of the savings and/or purchasing behaviors of various individuals 102.

As a fourth variation of this first aspect, the individual profile 202 may include a large variety of roles 120, such as various types of academic roles (e.g., a student, instructor, teaching assistant, researcher, advisor, or administrator); professional roles (e.g., an applicant, intern, employee, colleague, manager, consultant, or service provider); social roles (e.g., a family member, friend, or acquaintance); and gaming roles (e.g., a competitor, collaborator, and/or organizer). Such roles 120 may also be provided in various levels of detail, such as a general student role, or distinct roles for different classes. Many such scenarios may provide a context for utilizing the techniques presented herein.

E2. Role Determinants

A second aspect that may vary among embodiments of the techniques presented herein involves the manner of detecting a role determinant that may indicate the current role 212 of the individual 102, as well as the variety of role determinants 210 that may be detected and utilized in this context.

As a first variation of this second aspect, many types of details and sources of information may be utilized as role determinants 210 to determine the current role 212 of the individual 102. As a first such example, role determinants 210 may include actions of the individual 102, such as the user's gestures, expressions, and interaction with particular devices. As a second such example, role determinants 210. As a second such example, role determinants 210 may include descriptors of the individual 102, such as the individual's current location or destination; the individual's attire; the individual's possessions, such as a device that is in the individual's hand or pocket; and entries on the individual's calendar. As a third such example, role determinants 210 may include descriptors of the environment of the individual 102, such as other individuals 102 who are in the presence of the individual 102 or who are speaking to the individual 102 (e.g., the individual's family members, friends, or professional colleagues). Many types and sources of information may be utilized as role determinants 210 to determine the current role 212 of the individual 102.

As a second variation of this second aspect, a device 104 that integrates at least a portion of the techniques presented herein may determine, as a role determinant 210, the performance of an action by the individual 102. As a first such example, the device may receive user input from the individual 102 through an input device, such as a keyboard, mouse, or touch-sensitive display, whereby the individual 102 provides an explicit indication by the individual 102 that the individual 102 is interacting in a current role 212. As a second such example, the device 104 may evaluate the interaction of the individual 102 with various resources within the computing environment of the device 104, such as files, media, applications, network-accessible resources such as printers or network-attached storage (NAS) devices, websites, services, or component devices such as cameras or microphones, and may identify such resource accesses as a role determinant 210. As one such example, the device 104 may associate a first set of files or folders (such as documents relating to a professional project) with the individual's professional role, and a second set of files or folders (such as vacation photographs) with the individual's personal or family role, and may accordingly choose the current role 212 based on the files or folders that the individual 102 is currently accessing. As a third such example, the device 104 may evaluate communication between the individual 102 and other individuals, such as messages sent by the individual 102 and/or a voice dialogue engaged by the individual 102, to detect expressions by the individual 102 that are construed as role determinants 210 (e.g., an expression that the individual 102 is currently working, studying, or socially available). For example, a first set of keywords may be associated with the individual's academic role (e.g., “homework,” “class,” and “project”), and a second set of keywords may be associated with the individual's social role (e.g., “weekend,” “soccer,” and “party”), and the detection of a significant number of keywords in the individual's conversation or messages may indicate the current role of the individual 102. As a fourth such example, the device 104 may feature an accelerometer and/or gyroscopic sensor that detects a movement of the individual 102, such as a velocity, acceleration, and/or tilt of the individual 102, which may indicate a gesture performed by the individual while interacting with the device 104 (e.g., shaking the device) and/or incidentally detected by the device 104 (e.g., that the individual 102 is sitting, standing, walking, running, or lying down). For example, an individual may visit an athletic facility both for personal exercise and as a job. When the individual 102 is detected to be running at a jogging pace while located at the athletic facility, the device 104 may select an athletic role for the individual 102; and if the individual 102 is detected to be sitting stationary while located at the athletic facility, the device 104 may select a job role for the individual 102.

As a third variation of this second aspect, the device 104 may comprise an environment sensor that detects an environmental detail pertinent to the individual 102 that indicates a role determinant 210. The device 104 may infer different roles 120 of the individual 102 based on such environment details (e.g., determining that a location routinely visited by the individual 102 during work hours is the individual's workplace, and is associated with the individual's professional role 120), and/or may be explicitly instructed about such associations by the individual 102 (e.g., the individual may indicate that a particular location or type of activity is associated with a particular role 120). As a first such example, the device 104 may evaluate the date or time as a role determinant 210 of the individual 102 (e.g., determining whether the current date or time is a weekday, weekend, business hours, evening, late night, and/or holiday). As a second such example, the device 104 may evaluate metadata about the individual 102 to infer a role determinant 210, such as an appointment on the individual's calendar indicating that the individual 102 is expected to be in class. As a third such example, the device 104 may utilize a microphone to monitor discussion in the vicinity of the individual 102 (e.g., matching a detected voice with a voice print of the individual's teacher to determine that the individual is attending class). As a fourth such example, the device 104 may comprise a global positioning system (GPS) receiver that senses a current location of the individual 102, which may be interpreted as a role determinant 210 due to an association of the location with a current role 212 (e.g., detecting that the individual 102 is present on a school campus). As a fifth such example, the device 104 may detect other individuals in the proximity of the individual 102 (e.g., a camera may detect the faces of the individual's companions, or a network adapter may detect the proximity of other devices that are known to be carried by other known individuals), and may determine the current role 212 according to the identities of the individual's companions. As a sixth such example, a device may detect a proximity of other devices (e.g., the availability of a wireless network), and may associate the accessibility of the wireless network with a location that is in turn associated with a current role 212 of the individual 102.

As a fourth variation of this second aspect, the device 104 may receive a notification of a role determinant 210 from a second device. As a first such example, a mobile device, such as a mobile phone, may receive a signal from a wearable sensor, such as a wristwatch or shoe-embedded sensor, that the individual 102 has performed an action, such as a hand gesture or a physical activity. As a second such example, the device 104 may receive a notification from an environmental sensor, such as a presence detector or camera provided in a residence of the individual 102 to detect the individual's actions, and may associate the notification with a role determinant 210. As a third such example, the device 104 may receive a role determinant 210 as a notification from a server that provides a service to the individual 102 (e.g., a commercial service accessed by the individual 102, which detects that the individual 102 has engaged in a transaction that is associated with a current role 212). Many such role determinants 210 may be detected from many kinds of information in accordance with the techniques presented herein.

E3. Current Role Determination

A third aspect that may vary among embodiments of the techniques presented herein involves the determination of the current role 212 of the individual 102 based on the detection of one or more role determinants 210.

As a first variation of this third aspect, the individual profile 202 may associate the respective roles 120 of the individual 102 with role determinants 210. The device 104 may then determine the current role 212 of the individual 102 by determining which role 120 is associated in the individual profile 202 with a particular role determinant 210. As a first such example, the role determinants 210 may be specified as conditions, and the device 104 may, periodically and/or in response to an event, evaluate the conditions to determine whether any of the role determinants 210 are satisfied, and therefore whether a current role 212 of the individual 102 is to be selected. As a second such example, the device 104 may further comprise a trigger that associates a condition with a selected role 120, and may actively monitor the condition to detect a fulfillment of the condition of the trigger (e.g., a geofencing trigger that is automatically activated when the global positioning service (GPS) receiver of the individual 102 detects that the location of the individual has entered a particular region, such as a school campus). The device 104 may then select, as the current role 212, the selected role associated with the trigger having the fulfillment of the condition.

As a second variation of this third aspect, alternatively or additionally to the individual profile 202 indicating the role determinants 210 associated with respective roles 120, the device 104 may evaluate the set of role determinants 210 in an ad hoc manner in order to determine the current role 212 of the individual 102. As a first such example, the device 104 may compare various role determinants 210 with available sources of information to determine the roles 120 respectively associated therewith (e.g., comparing a current location of the individual 102 with a location database to determine the location type of the current location, such as determining that the individual 102 is located in a school building and is therefore likely interacting in a student role 120, or determining that the individual 102 is located at a restaurant and is therefore likely interacting in a social role 120). Further clarification of the current role 212 may be determined, e.g., by identifying companions of the individual 102 in order to determine whether the meeting is a social role 120 (e.g., when the individual 102 is accompanied by friends) or a professional role 120 (e.g., when the individual 102 is accompanied by professional colleagues). As a second such example, the device 104 may report role determinants 210 to a role determining service, which may evaluate various facts about the individual 102 and various environmental properties in order to determine the current role 212 of the individual 102.

As a third variation of this third aspect, various techniques may be utilized to determine the current role 212 of the individual 102 in view of ambiguous, and potentially conflicting, role determinants 210. Because some individuals 102 may frequently and fluidly switch among a significant set of roles 120, it may occasionally be difficult for the device 104 to determine the current role 212 of the individual 102. As a first such example, a particular location may be associated with two or more roles 120 (e.g., an individual 102 may visit a library either to study in a student role 120, or to select books and other media for casual consumption in a social role 120), and techniques may be utilized to determine which of several roles 120 is indicated by a detected role determinant 210. For example, the device 104 may determine whether the individual 102 tacitly accepts the current role 212 determined by the device 104, or whether the individual 102 responds by selecting a different current role 212 that indicates an adjustment of the determination. Additionally, the device 104 may continue to evaluate role determinants in order to verify the determination of the current role 212 (e.g., additional information that is consistent with the current role 212) or to contradict the current role 212 (e.g., additional information that conflicts with the selection of the current role 212).

As a second such example, different role determinants 210 may identify conflicting roles 120; e.g., the individual 102 may be located in a location that is associated with a first role 120, but may be using a mobile device to communicate with another individual who is associated with a second role 120. The device 104 may utilize a variety of techniques to determine which role 120 represents the current role 212 of the individual 102, and whether such roles 120 are mutually exclusive or complementary in this regard. For example, the device 104 may determine that the individual 102 interacts with a particular person fluidly in multiple roles, such as a professional colleague who is also an academic contact, friend, and/or teammate on an athletic team. While the individual 102 interacts with this person, the device 104 may concurrently select several current roles 120, and/or may seek role determinants that enable a finer selection of the current role 212 among the subset of roles 120 that apply to the person (e.g., specifically seeking keywords in a conversation between the individual 102 and the person pertaining to a shared academic class or an upcoming athletic event).

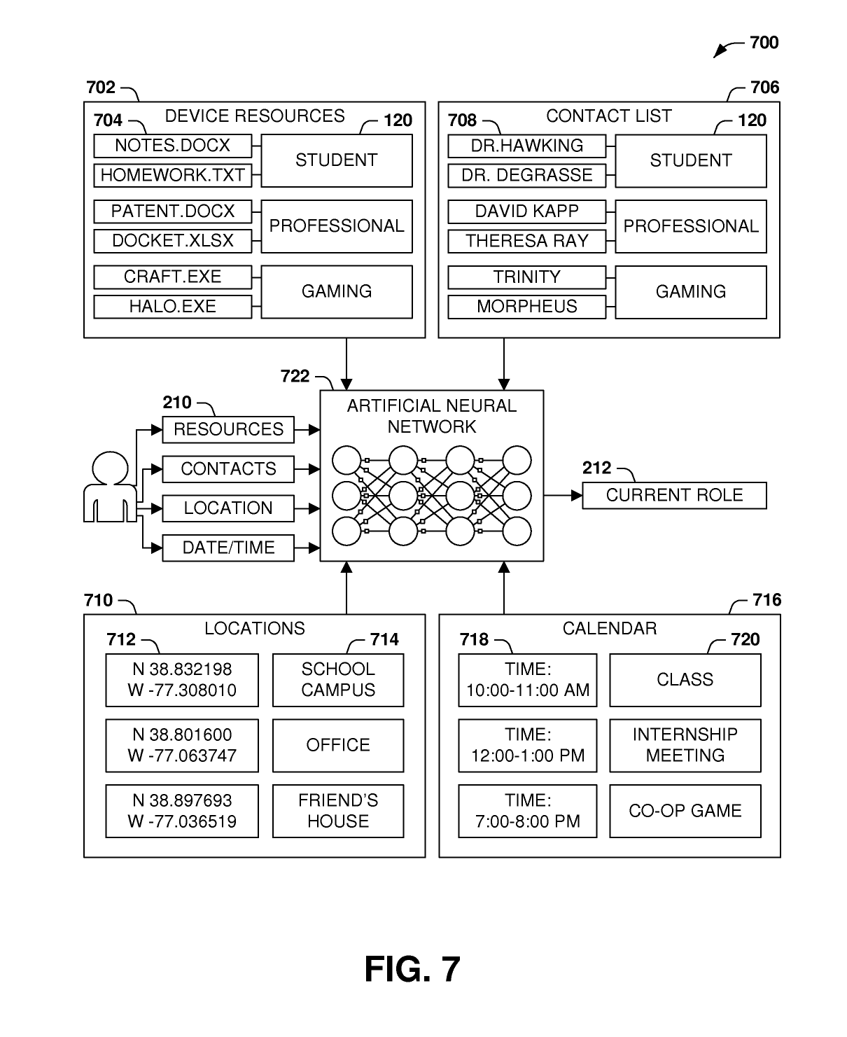

FIG. 7 presents an illustration of an example scenario 700 featuring an example of this third variation of this third aspect, wherein various sources of information provide role determinants 210 are available to determine the current role 212 of the individual 102. As a first such example, a set of device resources 702 may be provided on the device 104, such as files 704 that respectively represent content that may be associated with various roles 120 (e.g., class notes and homework assignments for a student role 120; task lists and projects for a professional role 120; and gaming applications for a gaming role 120). As a second such example, the device 104 may comprise a contact set 706 featuring a variety of contacts 708 that may be associated with a variety of roles 120 (e.g., instructors who interact with the individual 102 in a student role; colleagues of an organization who interact with the individual 102 in a professional role; and teammates who interact with the individual 102 in a gaming role). As a third such example, the device 104 may comprise a location set 710 featuring a set of coordinate sets 712 (e.g., geospatial coordinates defining the boundaries of a region) that respectively define a location 714 that, in turn, are associated with a role 120 (e.g., a school campus location 714 that the individual 102 visits in a student role 120; an office location 714 that the individual 102 visits in a professional role 120; and a friend's house location 714 that the individual 102 visits in a social role 120). As a fourth such example, the device 104 may comprise a calendar 716 featuring a set of dates and times 718 during which the individual 102 is anticipated to have an appointment 720 that is associated with a role 120 (e.g., a class appointment 720 that the individual 102 attends in a student role 120; a meeting appointment 720 that the individual 102 attends in a professional role 120; and a scheduled game appointment 720 that the individual 102 attends in a gaming role 120).

As further illustrated in this example scenario 700, at a particular time, the device 104 may determine that, among these various sources of information, a particular set of role determinants 210 may variously describe the current role 212 of the individual 102. Some role determinants 210 may conflict, while other role determinants 210 may be associated with two or more roles 120. A learning algorithm, such as an artificial neural network 722, may be provided to determine, among a set of role determinants 210, the current role 212 of the individual 102. For example, in a supervised learning model, the artificial neural network 722 may actively monitor the role determinants 210 and may receive guidance from a human trainer, including the individual 102, about the current role 212 of the individual 102 that is associated with various role determinants 210. Alternatively or additionally, the device 104 may compare the selection of a current role 212 based on a set of role determinants 210 with a set of training data, such as annotated exemplary data that indicates the current role 212 that is to be correctly selected in response to particular sets of role determinants 210. The device 104 may incrementally adjust the neuron weights of respective input and intermediate nodes of the artificial neural network 722 in order to reflect the significance of the respective role determinants 210 in signaling each role 120 as the current role 212 of the individual 102 (e.g., determining that a “library” location is highly indicative of the student role 120 of the individual 102; marginally indicative of a social role 120 of the individual 102; and not indicative, or even contraindicative, of a professional role 120 of the individual 102).

The training of the artificial neural network 722 may continue until the artificial neural network 722 is capable of consistently identifying the correct current role 212 of the individual 102 within a desired degree of confidence. The device 104 may then invoke the artificial neural network 722 to determine, among a set of role determinants 210 that currently describe the individual 102, the current role 212 that presents the highest correlation with the role determinants 210. The artificial neural network 722 may further be trained through feedback; e.g., if the individual 102 indicates that the artificial neural network 722 has incorrectly selected a first role 120 as the current role 212 rather than a second role 120, the artificial neural network 722 may adjust the neural weights of the role determinants 210 to promote the future selection of the second role 120 rather than the first role 120 in response to such role determinants. Many such learning algorithms and combinations thereof may be utilized in this capacity, such as genetic algorithms and Bayesian classification algorithms, and/or many types of supervised and unsupervised training methodologies (e.g., artificial Turk training methodologies) to achieve the configuration of the learning algorithms to identify the current role 212 in accordance with the techniques presented herein.

As a fourth variation of this third aspect, the device 104 may provisionally select a current role 212 of the individual 102, and may continue to monitor the role determinants 210 of the individual 102 for confirmation. As a first such example, the device 104 may ask the individual 102 to confirm a transition from a previous current role 212 to a new current role 212. As a second such example, an embodiment may remind the individual 102 that it is time to transition to a new current role 212 (e.g., based on the time and/or an interaction with another individual, prompting the individual 102 to transition to a student current role 212). For example, the device 104 may insert a popup notification of the new current role 212 into a visual and/or audial presentation (e.g., a whispered reminder inserted into a telephone conversation), and/or may offer a vibrational alert that signals the role transition to the individual 102. The individual 102 may confirm, refuse, and/or correct the suggestion of the new current role 212, and the device 104 may adapt the current role 212, as well as the determination process for selecting the current role 212, according to the response of the individual 102.

As a fifth variation of this third aspect, some roles 120 of an individual may be mutually exclusive, such that transitioning to a new current role 212 also involves transitioning out of a previous current role 212. Additionally, if an ambiguity exists among a set of roles 120, the device 104 may prompt the individual 102 to indicate which of the mutually exclusive roles 120 to select as the current role 212. The device may utilize the reply of the individual 102 to verify and/or adjust the selection of the current role 212, and/or to refine the determination process for greater accuracy in future current role selection. Alternatively, the device 104 may forgo selecting either role 120 as the current role 212 until continued monitoring of the role determinants 210 of the individual 102 indicates the role 120 to select as the current role 212.

As a sixth variation of this third aspect, some roles 120 may be compatible and/or complementary, and an individual 102 may concurrently interact in two or more roles 120, such as while interacting with a contact 708 comprising an instructor who both teaches the individual's class and a supervisor of an internship of the individual 102 (thus prompting a concurrent selection of the student role 120 and the professional role 120), or while interacting with a contact 708 who is both a fellow student in the same class as the individual 102 and also a friend of the individual 102 (thus prompting a concurrent selection of the student role 120 and the social role 120). In such scenarios, in addition to the selection of a current role profile 214 for a current role 212, the device 104 may detect a second role determinant 210 of a second role 120 that is typically associated with a second role profile 214 comprising a second individual profile detail 206 that is not included in the current role profile 214 of the current role 212. Accordingly, the device 104 may add the second role 120 to the current role 212 of the individual 102, and may add the second individual profile detail 206 of the second role profile 214 to the current role profile 214 of the individual 102, such that the current role profile 214 comprises a superset of the individual profile details 206 associated with the current role 212 and the individual profile details 206 associated with the second role 120. Additionally, the device 104 may resolve a conflict among the individual profile details 206 of two concurrently selected current roles 212, such as when a first role determinant 210 indicates a selection of a first current role 212 and a second role determinant 210 indicates a selection of a second, contradictory current role 212 (e.g., the individual 102 is present in a supermarket where personal shopping is typically performed, but coincidentally encounters a professional contact). The device 104 in a variety of ways (e.g., if a first role 212 includes the given name of the individual 102 and the second role 212 includes a pseudonym used by the individual 102 in the interest of privacy, the pseudonym may be selected as having priority over the given name of the individual 102).

As a seventh variation of this third aspect, responsive to detecting a new role determinant 210 that is not associated with a role 120, the device 104 may endeavor to determine which of the roles 120 is to be associated with the role determinant 210. For example, if the individual 102 is speaking with a previously unknown contact 708, the device 104 may endeavor to associate the unknown contact 708 with a second contact 708 who is associated with a role 120 of the individual 102, and/or may associate the unknown contact 708 with the current role 212 that is indicated by other role determinants 210; e.g., if the device 104 first detects a communication between the individual 102 and an unknown contact 708 in an office, the device 104 may associate the unknown contact 708 with the professional role 120 that is indicated by the location, and may consider further interaction with the unknown contact 708 to involve the professional role 120 of the individual 102 even if such further contact occurs away from the office. Moreover, such role determinants 210 may be monitored to determine a consistency among the associations of the role determinants 210 and the roles 120. Such continued monitoring by the device 104 may enable an adjustment of such associations in response to changing roles 120 over time; e.g., a contact 708 who the individual 102 first encounters in a classroom may initially be associated with a student role 120, but if the individual 102 consistently encounters the contact 708 thereafter in an office location, the embodiment may alter the evaluation of the contact 708 to a role determinant of a professional role 120.

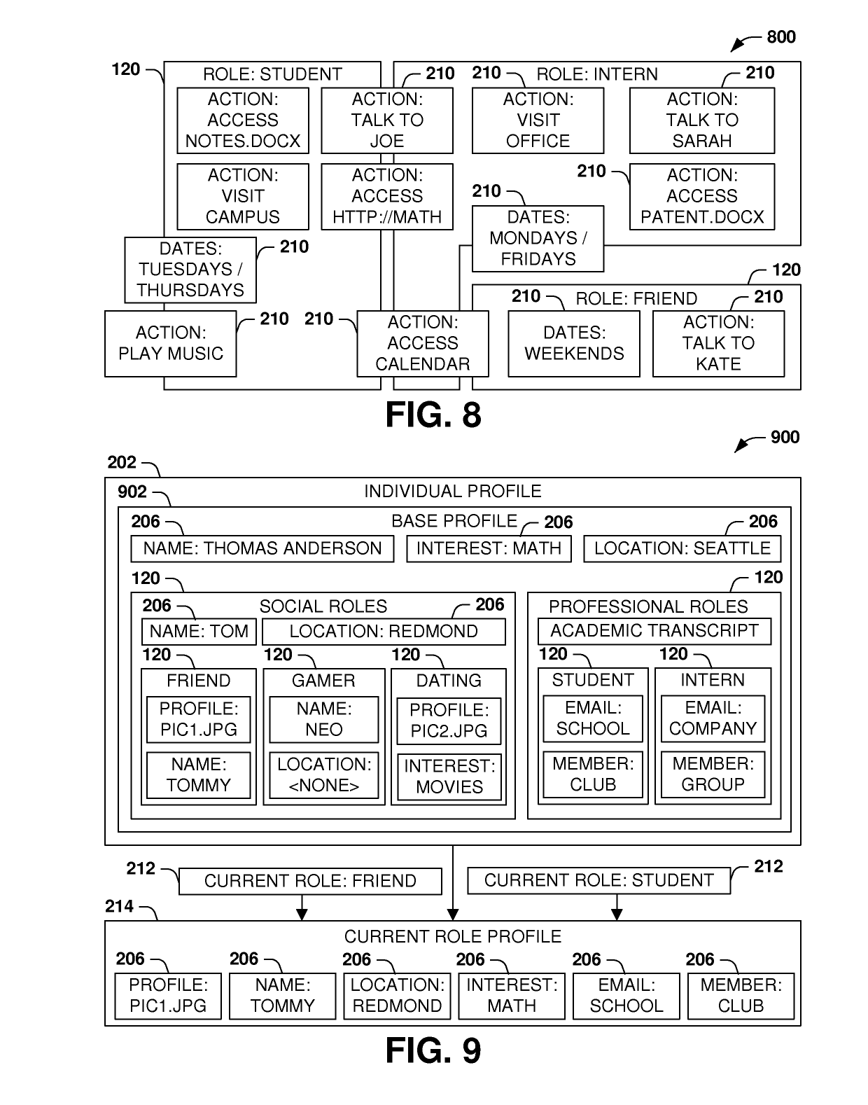

FIG. 8 presents an illustration of an example scenario 800 featuring one such technique for associating role determinants 210 with roles 120. In this example scenario 800, the device 104 utilizes a clustering technique to determine the correlation of each role determinant 210 with one or more other roles 120. Some role determinants 210 may overlap two or more roles 120, while other role determinants 210 may be ambiguous (e.g., may be only occasionally associated with a particular role 120, and partly not determining such a particular role 120, such as activities that the individual 102 performs during idle periods). A newly detected role determinant 210 may fit into the clustering (e.g., by positioning the role determinant 210 closer to correlated role determinants 210, and may lower the probability of selecting a role 120 based upon uncorrelated role determinants 210 that are not detected during the role 120, and may lower the probability still further for anticorrelated role determinants 210 that appear mutually exclusive with a particular role 120), and may therefore be associated with a role 120 of role determinants 210 that are most frequently detected as co-occurring during the selection of the role 120 as the current role 212 of the individual 102.

As an eighth variation of this third aspect, in addition to the automated selection of the current role 212 of the individual 102, embodiments may involve the participation of the individual 102 in such selection. As a first such example, a device may allow the individual 102 to specify a transition to a current role 212 explicitly, such as in a drop-down list of available roles, and may transition to the role selected by the individual 102. As a second such example, an embodiment may confirm the selection of the current role 212 with the individual 102, e.g., by presenting a prompt or notification informing the individual 102 of the selection, presenting the basis for the selection (e.g., the role determinants 210 involved in such selection), and/or soliciting the individual 102 to confirm the selection of the current role 212.

Still further variations of this third aspect, additional techniques may be utilized, alone or in combination with the other techniques provided herein, to inform the detection of role determinants 210 and the association of the role 120 of the individual 102 indicated thereby. As a first such example, a variety of data mining and information extraction techniques may be applied to a rich set of data describing the individual 102, including the individual's social profile; the individual's use of various services, such as the individual's recent purchase and travel history; and the details of people, objects, and events that relate to the user. As another example, online learning techniques may be applied to extrapolate associations between role determinants 210 of various users (e.g., the members of a social network or population, or specifically the user's social group) and the roles 120 indicated by such role determinants 210. For example, behavioral analysis may be applied to determine that individuals 102 often consume caffeinated beverages when engaged in a professional or student role, and alcoholic beverages when engaged in a social or casual role. These determinations from an online population may be applied to determine the association of a role determinant 210 for a particular individual 102 with a particular role 120, particularly if the role determinant 210 has not previously been evaluated with respect to the individual 102, or if the other role determinants 210 of the individual 102 create conflicting determinations about the current role 212 of the individual 102 that may be resolvable based on online learning or other information extraction techniques. Such techniques may be utilized prior to the determination (e.g., as a default or stock base of associations between role determinants 210 and roles 120), and/or on an ad hoc basis (e.g., when a new role determinant 210 is detected, or is determined to be ambiguous with respect to the current role 212 of the individual 102). Many such techniques may be utilized to determine the current role 212 of an individual in view of the detection of role determinants 210 in accordance with the techniques presented herein.

E4. Choosing Current Role Profile

A fourth aspect that may vary among embodiments of the techniques presented herein involves the selection, from among the individual profile details 206 of the individual profile 202, a subset of individual profile details 206 comprising a current role profile 214 for a current role 212 (e.g., including a selected individual profile detail 416, and excluding an individual profile detail 518 that does not relate to the current role 212 of the individual 102).

As a first variation of this fourth aspect, the individual 102 may specify the selected individual profile details 416 to be included in the respective roles 120. That is, the individual 102 may generate and/or refine the current role profile 214, such as the image and persona projected for the individual 102 while interacting in various roles 120. Such generation and/or curation may be expressly directed by the individual 102 to the device 104 (e.g., as a request to use a particular name for the individual 102 while interacting in a particular role 120), and/or may be detected by the device 104 while observing the actions of the individual 102 (e.g., detecting that while interacting in a particular role 120, the individual 102 often utilizes a particular name).

As a second variation of this fourth aspect, the device 104 may generate and store a current role profile 214 for a particular role 120, such that a subsequent selection of the role 120 as the current role 212 may enable a selection of the previously stored current role profile 214. A stored current role profile 214 may be periodically updated (e.g., regenerating the current role profile 214 for a role 120 on an hourly basis) and/or in response to adjustments of the individual profile 202; e.g., the device may periodically query a social network for updates to the individual profile details 206 of the social profile of the individual 102, and may automatically categorize such individual profile details 206 to produce the current role profile 214. Such regeneration may facilitate the freshness of the current role profile 214, such as steadily diminishing the significance of contacts 708 and interests with which the individual 102 no longer participates, and actively including new interests of the individual 102 based on recent changes to the roles 120 of the individual 102. Alternatively, the device 104 may composite the current role profile 214 for a particular role 120 responsive to selection of the role 120 as the current role 212. For example, the device 104 may determine, on an ad hoc basis, which individual profile details 206 are to be used to represent the individual 102 in the current role 212, such as by querying a social network from which an individual profile detail 206 has been retrieved with an inquiry about the role 120 associated with the individual profile detail 206; by associating a newly detected role determinant 210 with the current role 212 of the individual 102 when such role determinant 210 was detected or performed; and/or by asking the individual 102 to specify the role 120 associated with an individual profile detail 206 when automated association is ambiguous.

As a third variation of this fourth aspect, the roles 120 of an individual 102 may be specified in a hierarchical manner in order to provide varying levels of detail, which may enable sophistication in the selection of individual profile details 206 to include in the current role profile 214 in different circumstances. For example, rather than establishing a single current role profile 214 for a social role 120 that the individual 102 utilizes with all social contacts 708, the device 104 may identify a hierarchy of social roles 120 (e.g., different identities that the individual 102 exhibits or wishes to exhibit among different subsets of contacts 708). For instance, the individual 102 may choose to share one set of individual profile details 206 as the current role profile 214 while interacting only with a close friend, but may choose to reserve some such individual profile details 206 while interacting with the close friend in the presence of less personal friends and/or mutual acquaintances.

Moreover, the device 104 may interpret the hierarchical structure of the roles 120 of the individual profile 202 in a variety of ways. As a first such example, the individual profile 202 may include a base profile, comprising at least one base individual profile detail 108 that the device 104 includes in the current role profiles 214 of all of the roles 120 (e.g., an interest in mathematics, a religious belief, or a dietary or health condition that the individual 102 wishes to express in every role 120). As a second such example, the device 104 may supplement the individual profile details 206 of a hierarchically superior role 120 with the individual profile details 206 of a hierarchically subordinate role 120, such as a high-priority individual profile detail 108 that is to take precedence over other individual profile details 108 (e.g., the individual profile details 108 that relate to the individual's family may supersede any conflicting individual profile details 108 in other individual profiles 202). As a third such example, the device 104 may interpret a first individual profile detail 206 in a hierarchically subordinate role 120 as superseding a second individual profile detail 206 in a hierarchically superior role 120; e.g., an individual 102 may indicate that a particular individual profile detail 206 is to be withheld while interacting with a particular set of contacts 708 in the interest of anonymity and/or privacy, even if the individual profile detail 206 is to be included in the current role profile 214 of a more general role 120. In these and other ways, an individual profile 202 structured as a set of hierarchically structured roles 120 may reflect the subtleties of such interactions and current role profiles 214 associated therewith.

FIG. 9 presents an illustration of an example scenario 900 featuring an individual profile 202 that is structured hierarchically in accordance with this third variation of this fourth aspect. In this example scenario 900, the device 104 stores an individual profile 202 including a base profile 902 that features individual profile details 206 to be used by default, such as the formal name of the individual 102 and a regional location of residence (e.g., the city where the individual 102 resides). The device 104 further stores, as part of the individual profile 202, a set of social roles 120 that supersede the name of the individual 102 with the individual's familiar name and a more specific location (e.g., the particular neighborhood of the city); and within the social roles 120, more specific sets of individual profile details 206 may be specified for more specific social roles 120, such as a first profile picture to be used while the individual 102 is in a friendly social role 120, and a second profile picture to be used while the individual 102 is in a dating social role 120. Moreover, some roles 120 may indicate a withholding of individual profile details 206 that are included in the broader social context; e.g., while interacting in a gaming social role, the individual 102 may utilize a pseudonym and may withhold the individual's city of residence in the interest of privacy. A second set of roles 120 may be provided for social roles 120, such as a student role 120 and a professional intern role 120. The individual profile 104 may be used to generate the current role profile 214, and may even inform the generation of such a profile for concurrently selected current roles 212, such as specifying whether particular individual profile details are to be included when generating a current role profile 214 for a current role 212 (e.g., the individual profile 104 may indicate that a particular individual profile detail is sensitive to the individual 102, and is to be included in the current role profile 214 only in trusted circumstances, such as when the individual 102 is in a family role at home). As another example, if the individual 102 is interacting with a contact 708 who is both a fellow student (such that a scholastic role 120 may be selected as the current role 212) and a friend (such that a social role 120 may be selected as the current role 212), the current role profile 214 may be generated as an aggregation of the individual profile details 206 associated with each role 120.

As a fourth variation of this fourth aspect, the device 104 may utilize a current role profile template to generate the current role profile 214 for a current role 212 from the individual profile 202. For example, a social profile template may specify that the individual's current location is to be included whenever a social role 120 is selected as the current role 212. As one such example, a current role profile template may be generated based on an evaluation of the current role profiles 214 of a number of individuals 102 (e.g., determining, among a social network, which individual profile details 206 the individuals 102 frequently choose to share as part of a current role profile 214, and which individual profile details 206 the individuals 102 choose to reserve as private). In some scenarios, a learning algorithm may be utilized to determine such details, based upon, e.g., a classification of the individual 102 with other individuals 102 of a particular culture, community, or geographic region.

As a further example of this fourth variation of this fourth aspect, the device 104 may present to the individual 102 a role catalog, comprising at least one role template for a suggested role 206 of the individual 102. For example, when an individual 102 joins a service 108 such as a social network, the service 108 may provide to the individual 102 a role catalog of role templates that the individual 102 may choose to represents his or her identity and persona within the social network (e.g., a low-privacy role template that includes all but the most sensitive individual profile details 206 of the individual profile 202 in the current role profile 214 for the social role 120, and a high-privacy role template that includes only basic individual profile details 206 of the individual profile 202 in the current role profile 214 for the social role 120). Responsive to receiving a selection of a selected role template from the individual 102, the device 104 may add the suggested role 120 of the selected role template to the roles 120 of the individual 102, and store the selected role template. Thereafter, when the suggested role is selected as the current role 212, the selected role template for the suggested role 120 may be applied to the individual profile 102 to select the current role profile 214.

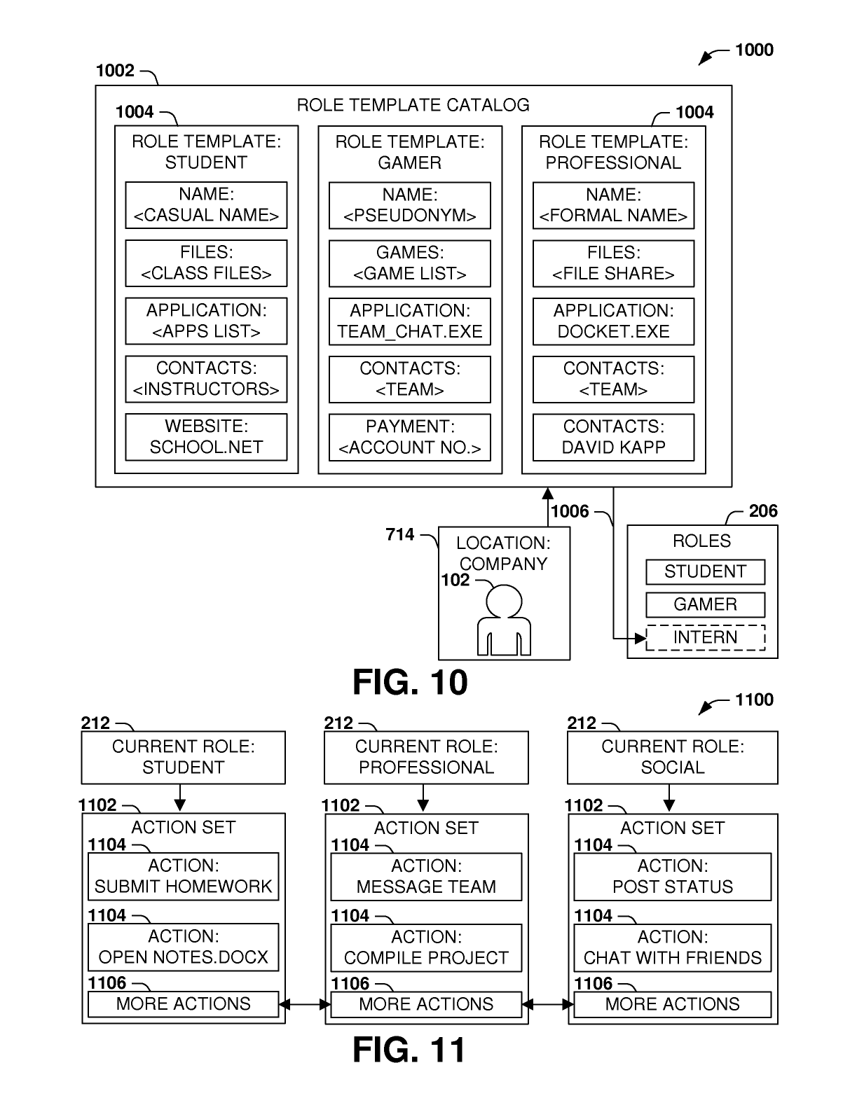

FIG. 10 presents an illustration of an example scenario 1000 featuring a role template catalog 102, comprising a set of role templates 1004 that are applicable to the individual profile 202 of the individual 102 in order to generate a suitable representation for a stock set of roles 120. In this example scenario 1000, as a first example, a student role template 1004 indicates a subset of individual profile details 206 that may be selected to represent the individual 102 as a type of student (e.g., the individual's casual name, home address, basic class list, clubs list, and interests list). As a second example, a professional role template 1004 indicates a subset of individual profile details 206 that may be selected to represent the individual 102 as a type of professional (e.g., the individual's formal name, city of residence, full class transcript including grades, and list of skills and projects that the individual 102 is utilizing in the professional context). As a third example, a customer role template 1004 indicates a subset of individual profile details 206 that may be selected to represent the individual 102 as a type of customer of a commercial service 108 (e.g., the individual's casual name, the nearest city to the individual's residence that includes a store for the service 108, a list of interests for targeted advertisements, a list of previously purchased products of the service 108, and payment account information). Responsive to arriving at a location 714 such as a store for the service 108, the device 104 presents to the individual 102 a suggestion to create a role 120 representing the individual 102 as a customer of the service 108. Responsive to receiving an acceptance of the suggestion, the device 104 may deploy the suggested role template 1004 into the individual profile 202 to create a customer role 120 for the individual 102, and to generate the current role profile 214 when the customer role 120 is selected as the current role 212. Many such techniques may be utilized to generate the current role profile 214 for a current role 212 in accordance with the techniques presented herein.

E5. Role-Specific Device Behavior Adjustment

A fifth aspect that may vary among embodiments of the techniques presented herein involves the manner of adjusting the device behavior 106 of the device 104 according to the current role 212 and current role profile 214 of the individual 102.

As a first variation of this fifth aspect, the device 104 may present the computing environment to the individual 102 through a user interface presented according to a variety of user interface properties. Such user interface properties may include, e.g., visual properties such as the desktop resolution and contents, colors, desktop background, window positions and sizes, and fonts styles and sizes; audio properties such as the volume levels, sound effects, and ringtones of the device 104; and functional properties such as the behavior of menus, task lists, task switchers, power savings settings, and background processes of the device 104. Accordingly, the device behavior 106 may be adjusted in a role-specific manner by selecting, among at least two user interface properties, a selected user interface property that is associated with the current role profile 214 of the current role 212 of the individual 102. For example, the individual profile 202 may specify that, while viewing a document, the individual 102 prefers a first font style while viewing the document in a first role 206, and a different font style while viewing the document in a second role 206. The device 104 may alter the device behavior 206 by selecting the user interface properties of the user interface according to the current role 212 of the individual 102.

As a second variation of this fifth aspect, the device 104 may present to the individual 102, within the computing environment, a file system 108 comprising a set of files 110 and/or folders, and may detect that the files 110 accessed by the individual 102 while interacting with the device 104 in a first role 120 are limited to a first file and/or folder set, and that the files 110 accessed by the individual 102 while interacting with the device 104 in a second role 120 are limited to a second file and/or folder set. Accordingly, the device 104 may limit the presentation of files 110 and/or folders to the individual 102 to the file and/or folder set that is associated with the current role 212 of the individual 102. For example, the device 104 may identify, among at least two files 110 of the file system 108, a first file that is associated with the current role 212, and a second file that is not associated with the current role 212; and may adjust the device behavior 106 of the device 104 by presenting to the individual 102 a current role file set that comprises the first file and excludes the second file. The constrained file set of the current role 212 may be presented to the individual 102 as an initial menu, featuring an option to view and access the other files 110 and/or folders available through the file system 108, thereby facilitating access by the individual 102 to the files 110 utilized with the highest frequency while the individual 102 interacts with the device 104 in the current role 212.

As a third variation of this fifth aspect, the device 104 may present to the individual 102, within the computing environment, a set of applications that the individual 102 may select to achieve various tasks, such as a web browser, a text editor, a software development environment, and a media player. The device 104 may detect that the applications utilized by the individual 102 while interacting with the device 104 in a first role 120 are limited to a first application set, and that the applications utilized by the individual 102 while interacting with the device 104 in a second role 120 are limited to a second application set. Accordingly, the device 104 may limit the presentation of applications to the individual 102 to the application set that is associated with the current role 212 of the individual 102. For example, the device 104 may identify, among at least two applications of the complete application set that is available on the device 104, a first application that is associated with the current role 212, and a second application that is not associated with the current role 212; and may adjust the device behavior 106 of the device 104 by presenting to the individual 102 a current role application set that comprises the first application and excludes the second application. The constrained application set of the current role 212 may be presented to the individual 102 as an initial menu, featuring an option to view and access the other applications available on the device 104, thereby facilitating access by the individual 102 to the applications utilized with the highest frequency while the individual 102 interacts with the device 104 in the current role 212. As a still further example, the adaptation of the device behavior 106 may also include, e.g., different application configurations of a particular application that are respectively associated with a different role 212 of the individual 102, wherein, upon receiving a request to invoke a selected application, the device 104 automatically selects the application configuration of the selected application that is associated with the current role 212 of the individual 102.

As a fourth variation of this fifth aspect, the device 104 may present to the individual 102, within the computing environment, a set of uniform resource identifiers (URIs) that the individual 102 may select to visit various websites and/or utilize various web services over a local area network (LAN) and/or wide-area network (WAN). The device 104 may also detect that the URIs utilized by the individual 102 while interacting with the device 104 in a first role 120 are limited to a first URI set, and that the URIs utilized by the individual 102 while interacting with the device 104 in a second role 120 are limited to a second URI set. Accordingly, the device 104 may limit the presentation of URIs to the individual 102 to the URI set that is associated with the current role 212 of the individual 102. For example, the device 104 may identify, among at least two URIs, a first URI that is associated with the current role 212, and a second URI that is not associated with the current role 212; and may adjust the device behavior 106 of the device 104 by presenting to the individual 102 a current URI application set that comprises the first URI and excludes the second URI. The constrained URI set of the current role 212 may be presented to the individual 102 as an initial menu, featuring an option to view and access the other URIs accessed by the individual 102 in other roles 120, thereby facilitating access by the individual 102 to the URIs utilized with the highest frequency while the individual 102 interacts with the device 104 in the current role 212.

FIG. 11 presents an illustration of an example scenario 1100 featuring a fifth variation of this fifth aspect, wherein the device 104 presents to the individual 102 a set of actions 1104 that may facilitate the work flow and completion of tasks of the individual 104. In accordance with the techniques presented herein, the device 104 may be capable of identifying the actions 1104 that the individual 102 frequently performs while interacting with the device 104 in a particular role 120, such as accessing files or documents, or invoking various processes or services. The device 104 may achieve this determination, e.g., by receiving instructions from the individual 102, and/or by detecting frequently occurring patterns of activity within the computing environment (e.g., sending a particular file to a second individual on a particular date; visiting a particular website; or running a data archiving process), and generating a script that may be invoked to perform the action 1104. Accordingly, when the device 104 selects a current role 212 for the individual 102, the device 104 may present to the individual 1102 an action set 1102 comprising the frequently performed actions 1104 that are associated with the current role 212. Moreover, the device 104 may also present an option 1106 enabling the individual 102 to view the actions 1104 that are associated with other roles 120, such that the individual 102 may be initially presented with the actions 1104 associated with the current role 212 (e.g., by identifying, among the at least two actions 1104, a first action 1104 that is associated with the current role 212, and a second action 1104 that is not associated with the current role 212, and accordingly presenting to the individual 102 an action set 1102 comprising the first action 1104 and excluding the second action 1104), but may also access the full set of actions 104 associated with all such roles 120.

As a sixth variation of this fifth aspect, the device 104 may comprise a contact set 116 comprising at least two contacts 118. The device 104 may also be capable of determining that the respective contacts 118 are respectively associated with at least one role 120 of the individual 102, and may adjust the device behavior 106 of the device 102 by presenting to the individual 102 a constrained contact set 116 comprising the contacts 118 who are associated with the current role 212 of the individual 102. For example, the device 104 may identify, among the contacts 118 of the contact set 116, a first contact 118 that is associated with the current role 212, and a second contact 118 that is not associated with the current role 212; and may present to the individual 102 a current role contact set comprising the first contact 118 and excluding the second contact 118. The constrained contact set 116 of the current role 212 may be presented to the individual 102 as an initial list, featuring an option to view and access the other contacts 118 accessed by the individual 102 in other roles 120, thereby facilitating access by the individual 102 to the contacts 118 utilized with the highest frequency while the individual 102 interacts with the device 104 in the current role 212.

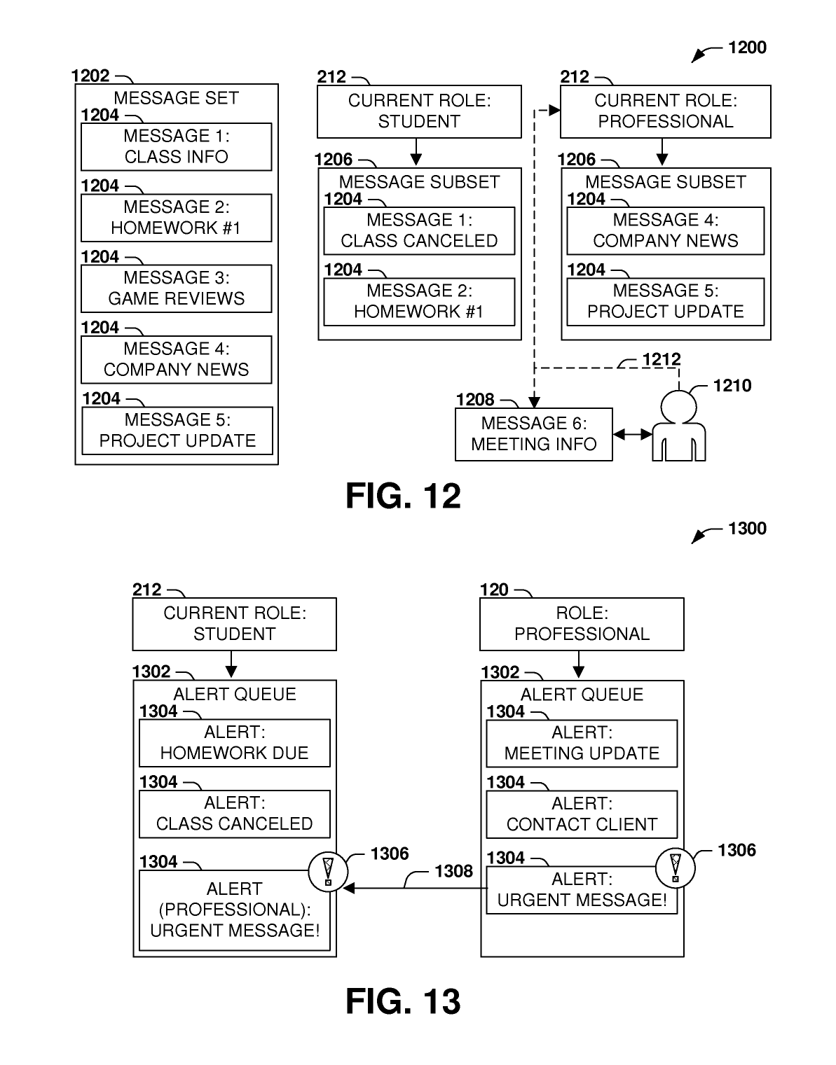

FIG. 12 presents an illustration of an example scenario 1200 featuring a seventh variation of this fifth aspect, wherein the device 104 adapts the device behavior 106 to the current role 212 of the individual 102 by presenting a set of messages 1204 that are associated with the current role 212. In this example scenario 1200, a message set 1202 comprises a large number of messages 1204 respectively involving various senders and/or recipients; featuring various forms of data, such as text, audio, images, video, or associated data objects; and/or transmitted at various dates and times through various communication channels, such as email messages, simple message service (SMS) and/or media messaging service (MMS) messages, and chat messages in a chat environment. The device 104 may determine that among the messages 1204 of the message set 1202, a particular subset of the messages 1204 relate to the current role 212 of the individual 102 (e.g., messages 1204 sent by contacts 118 who are associated with the current role 212 of the individual 102; messages 1204 that are sent through a messaging account of the individual 102 that is associated with the current role 212, such as a professional mail account; and messages 1204 that relate to topics that are associated with the current role 212), and that other messages 1204 are not related to the current role 212 of the individual 102 (e.g., matching one or more of the individual profile details 206 of the current role profile 214 of the current role 212). Accordingly, the device 104 may adjust the device behavior 106 according to the current role 212 of the individual 102 by presenting a message subset 1206 that is limited to the messages 1204 of the message set 1202 that relate to the current role 212 of the individual 102. For example, the device 104 may identify, among at least two messages 1204 of the message set 1202, a first message 1204 that is associated with the current role 212 and a second message 1204 that is not associated with the current role 212, and may present to the individual a current role message set comprising the first message 1204 and excluding the second message 1204. The device 104 may further utilize the messages 1204 to determine the role determinants 210 of the respective roles 120; e.g., upon detecting that the individual 102 initiates a new message 1208 and/or message reply that includes or relates to a new individual 1210 while the individual 102 is interacting with the device 104 in a current role 212, the device 104 may associate 1212 the new individual 1210 with the current role 212 of the individual 102, such that future messages 1204 exchanged with the new individual 1210 may automatically be included in the current role message set that is associated with the current role 212.

FIG. 13 presents an illustration of an example scenario 1300 featuring an eighth variation of this fifth aspect, wherein the device 104 adjusts the device behavior 106 by presenting alerts that are related to the current role 212 of the individual 102. In this example scenario 1300, the device 104 may comprise a set of alerts 1304 to be presented to the individual 104. The device 104 may also be capable of determining that respective alerts 1304 are respectively associated with one or more roles 120, and may generate an alert queue 1302 for each role 120 that comprises the alerts 1304 to be presented when the individual 102 is interacting with the device 104 in the associated role 120. For example, responsive to receiving a first alert 1304 that is associated with the current role 212 of the individual 102, the device 104 may present the first alert 1304 to the individual 102; and responsive to receiving a second alert 1304 that is not associated with the current role 212 of the individual 102, the device 104 may refrain from presenting the second alert 1304 to the individual 102, and may instead store the second alert 1304 in an alert queue 1302 for a second role 120 with which the second alert 1304 is associated. When the device 104 later detects a transition of the individual 102 to the second role 120 as the current role 212, the device 104 may present to the individual 102 the alerts 1304 of the alert queue 1302 for the second role 120. Moreover, the device 104 may adjust this presentation according to an alert priority 1306 of the respective alerts 1304. For example, upon receiving an alert 1304, the device 104 may determine the alert priority 1306 of the alert 1304 (e.g., according to an explicitly statement associated with the alert 1304, or based on an evaluation of the content of the alert 1304), and may determine whether the alert priority 1306 of the alert 1304 exceeds an alert priority threshold. Responsive to determining that the alert priority 1306 exceeds the alert priority threshold, the device 104 may present 1308 the alert 1304 to the individual 102 during selection of the current role 212 of the individual 102, even if the alert 1304 is not associated with the current role 212 of the individual 102. Optionally, in conjunction with presenting the alert 1304 to the individual 102 during the interaction with the device 104 in the current role 212, the device 104 may also remove the alert 1304 from the alert queue 1302 associated with the second role 120.

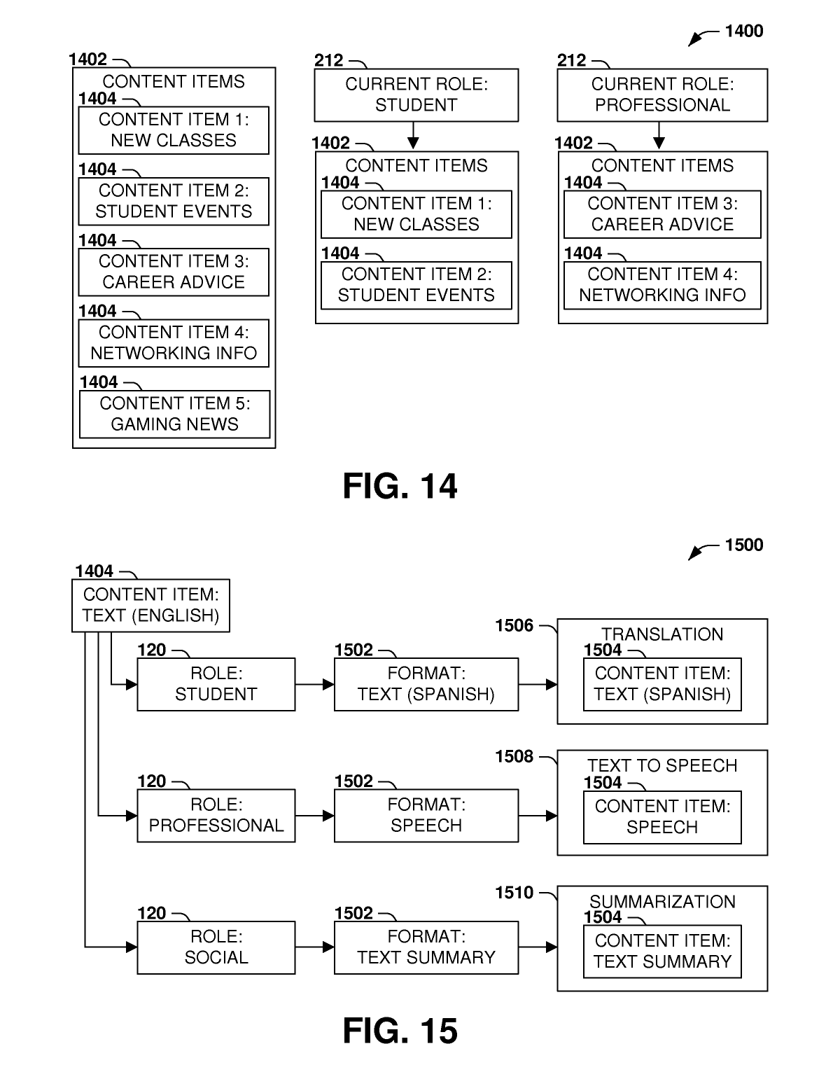

FIG. 14 presents an illustration of an example scenario 1400 featuring a tenth variation of this fifth aspect, wherein the device 104 receives a content item set 1402 of content items 1404, such as written articles, websites, or files that are sent to and/or encountered by the device 104. The device 104 may be capable of associating the respective content items 1404 with one or more roles 120 of the individual 102, and may adjust the device behavior 106 by presenting to the individual 102 only the content items 1404 that are associated with the current role 212 of the individual 102. For example, responsive to receiving a first content item 1404 that is associated with the current role 212 of the individual 102, the device 104 may present the first content item 1404 to the individual 102; and responsive to receiving a second content item 1404 that is not associated with the current role 212 of the individual 102, the device 104 may refrain from presenting the second content item 1404 to the individual 102. Optionally, the device 104 may store the second content item or a reference thereto in a content item set 1402 that is associated with a second role 120 of the individual 102, and may subsequently present the content item set 1402 associated with the second role 120 responsive to detecting that the individual 102 has transitioned to the second role 120 as the current role 212 of the individual 102. In this manner, the device 104 may filter the content items 1404 presented to the individual 102 to those that relate to the current role 212 of the individual 102, while preserving other content items 1404 for presentation to the individual 102 in different roles 120.

FIG. 15 presents an illustration of an example scenario 1500 featuring a tenth variation of this fifth aspect, wherein the device 104 adjusts the device behavior 106 by presenting a content item 1304 using a selected content item format 1502 that is associated with the current role 212 of the individual 102. In this example scenario 1500, the respective roles 120 of the individual 102 are associated with a content item format 1502 that the individual 102 wishes to apply to content items 1304. For example, a first role 120 may involve a first content item format 1502 of the content item 1404 translated into a different language; a second role 120 may involve a second content item format 1502 of the content item 1404 translated into a different content modality, such as translating text to speech; and a third role 120 may involve a third content item format 1502 of the content item 1404 that is paraphrased into a text summary. Accordingly, upon receiving a content item 1404 to be presented to the individual 102, the device 104 may determine the content item format 1502 that is associated with the current role 212 of the individual 102, and may apply the content item format 1502 to the content item 1404 before presenting a translated content item 1504 to the individual 102 (e.g., invoking a language translation technique 1506 to produce a translated content item 1504 in a different language; invoking a text-to-speech translator 1508 to translate a textual content item 1404 into a spoken-word content item 1404; and/or invoking a summarization translator 1510 to generate a text summary of the content item 1404). In this manner, the device 104 may adjust the device behavior 106 according to the current role 212 of the individual 102 by automatically translating content items 1404 using the content item format 1402 of the current role 212 of the individual 102.

As an eleventh variation of this fifth aspect, the device 104 may log events in association with the current role 212 of the individual 102. For example, responsive to updating an event log in order to log an event, the device 104 may detect the current role 212 of the individual 102, and may log the current role 212 of the individual 102 with the event in the event log. Many such variations may be utilized to adapt the device behavior 106 of the device 104 according to the current role 212 of the individual 102 in accordance with the techniques presented herein.

E6. Privacy Considerations

A sixth aspect that may vary among embodiments of the techniques presented herein involves the manner of accounting for the privacy sensitivity of the individual 102 in the application of the techniques presented herein.

As a first variation of this sixth aspect, the monitoring of role determinants 210 may be adapted to evaluate particular types of information and/or sources, but not to evaluate other types of information and/or sources. For example, an individual 102 may be amenable to the adaptation of the device behavior of the device based upon the individual's device usage (e.g., applications utilized) and navigation history, but uncomfortable with the adaptation of the device behavior of the device based upon the individual's conversations and interaction with online services. Various aspects of the monitoring may therefore be adapted to enable the individual 102 to specify whether the device is to utilize, or not utilize, various types and/or sources of information in the monitoring of role determinants 210 and the identification of the current role 212 of the individual 102.

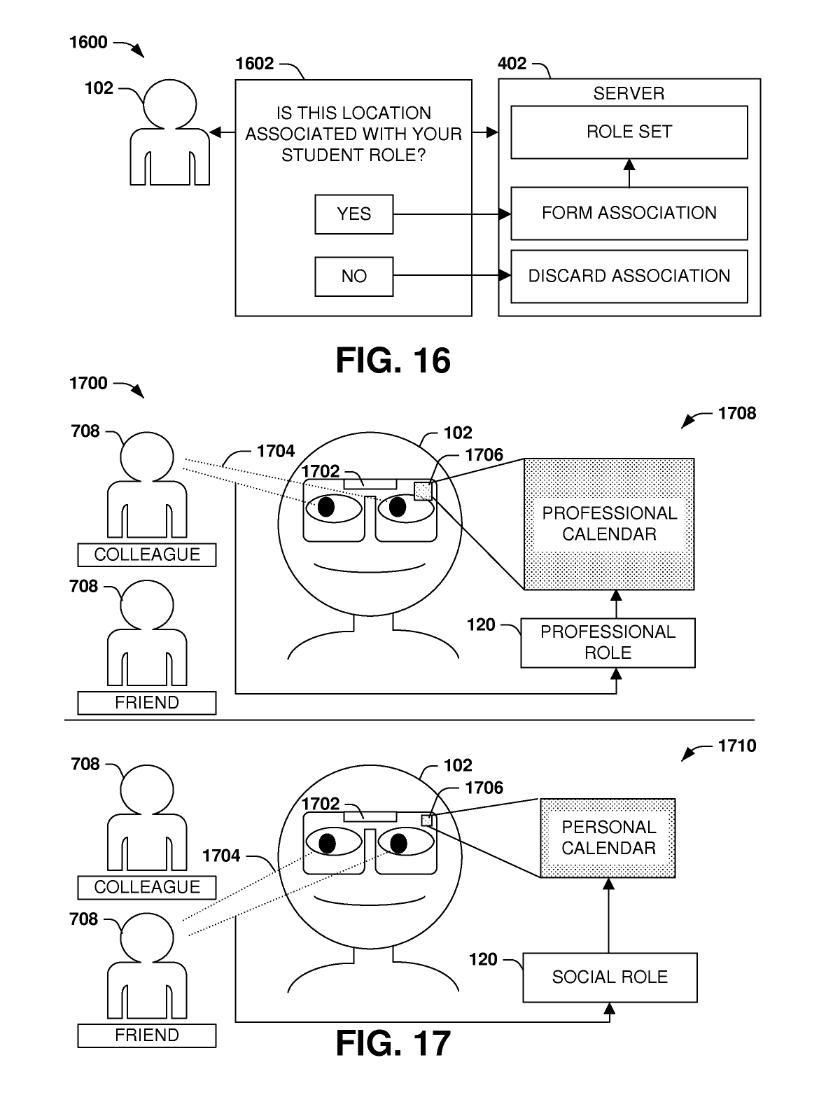

FIG. 16 presents an illustration of an example scenario 1600 involving a second variation of this sixth aspect, involving the full notification and consent of the individual 102 in the adaptation of the device behavior of a device. In this example scenario 1600, a server 402 is provided that monitors a set of role determinants 210 of an individual 102, and forms associations between detected role determinants 210 and the current role 212 of the individual 102, in order to enable devices interacting with the individual 102 to adapt device behaviors. However, in some respects, such monitoring and automated evaluation may be surprising or undesired by the individual 102; e.g., an embodiment that is too savvy and accurate at monitoring the role determinants 210 of the individual 102 may impart an unpleasant sense of over-monitoring and/or continuous evaluation. As another example, scenarios in which the detection of the current role 212 of the individual 102 is achieved in a manner that is surprising to the individual 102 may appear to be uncanny, and the individual 102 may be uncomfortable with such automated adaptation without understanding the mechanics of the determination. Accordingly, the server 402 may make the formation of associations between role determinants 210 and respective roles 120 of the individual 102 contingent upon explicitly informing the individual 102 of such associations, and/or receiving consent from the individual 102 to form and utilize such associations. For example, a particular location may be heavily correlated with the individual's participation in a student role 120, but the individual 102 may not be aware of the correlation, and automatically switching to the student role when the user approaches the location may surprise the individual 102. Such discomfort may be alleviated by presenting to the individual 102, before establishing the association, information that expresses the correlation to the individual 102, and an offer 1602 to associate the location (as a role determinant 210) with the student role 120. If the server 402 receives an acceptance of the offer 1602 from the individual 102, the server 402 may form the association and thereafter utilize the detection of the location to select the student role 120 as the current role 212 of the individual 102; and upon failing to receive an acceptance of the offer 1602, the server 402 may determine that the individual 102 does not wish the current role 212 to be selected based on this location, and may refrain from forming the association. In this manner, the server 402 may fully apprise the individual 102 of the mechanics of the role determination and device adaptation, and may make such adaptation contingent upon the consent of the individual 102.

As a third such example, various forms of “privacy modes” may be included to perform role determination in a privacy-sensitive manner. As a first such example, a device 302 or server 402 may include a toggle for a “privacy mode,” which, when activated, reduces the monitoring of role determinants 210, the determination of a current role 212, and/or the adaptation of device behaviors of a device 302. As a second such example, a “privacy mode” may be applied as a threshold, e.g., such that less privacy-centric role determinants 210 are utilized in role determination, and more privacy-centric role determinants 210 are not utilized in role determination. As a third such example, a “privacy mode” may be automatically activated and/or deactivated; e.g., upon determining that a conversation involving the individual 102 includes terms that are associated with a high privacy sensitivity, a device 302 or server 402 may temporarily refrain from detecting or utilizing role determinants 210. Many such mechanisms for respecting the privacy of the individual 102 may be devised and included in the application of the techniques presented herein.

E7. Wearable Device Examples

Some examples of scenarios that are particularly adaptable to the utilization of the techniques presented herein involve the use of “wearable” devices. Such devices are often utilized in a more casual manner; e.g., an individual 102 may continuously possess and wear such devices in both scenarios where the individual 102 is willing to interact with a device, and in scenarios where the individual 102 wishes to minimize device interaction, such as social engagements. The techniques presented herein may be advantageous in such scenarios to provide automated device behavior adaptation in a manner that reduces the distraction and interruption of the attention of the individual 102. For example, the device may store a variety of information that is of value to the individual 102 in various scenarios, but detecting and using the role determinants 210 to adapt the manner in which the device interacts with the individual 102 may reduce the amount of user interaction with the device to access the information that is relevant to the current role 212 of the individual 102.

FIG. 17 presents an illustration of an example scenario 1700 featuring one such wearable device, comprising eyewear 1702 that is capable both of tracking the gaze of the individual 102 and presenting information within the visual field of the individual. As a first example, the eyewear 1702 may evaluate the activities of the individual 102 with other people and aspects of the environment, such as detecting, among a set of people in the vicinity of the individual 102, a particular contact 708 with whom the individual 102 is currently interacting, and may utilize the relationship between the individual 102 and the contact 708 as a role determinant 210 of the current role 212 of the individual 102. For example, the eyewear 1702 may apply a gaze-tracking technique 1704 to detect when the individual 102 is engaging with a first contact 708 who is a professional colleague, and when the individual 102 is engaging with a second contact 708 who shares a friendship with the individual 102. Accordingly, at a first time 1708 when the individual 102 is interacting with a contact 708 who has a professional relationship with the individual 102, and the device may choose a professional role 120 as the current role 212 of the individual 102; and at a second time 1710 when the individual 102 is interacting with a contact 708 who has a friendship with the individual 102, and the device may choose a social role 120 as the current role 212 of the individual 102. As a second such example, the eyewear 1702 may vary both the selection and the presentation of information according to the current role 212 of the individual 102. For example, at a first time 1708, when the individual 1702 is in a professional current role 202, the eyewear 1702 may include a larger display overlay 1706 that presents a professional calendar in a large size that presents a significant amount of information that is relevant to the current role 212. However, at a second time 1708, when the individual 1702 is in a social current role 212, the eyewear 1702 may include a smaller display overlay 1706 that presents a personal calendar in a smaller size that is less likely to distract the attention of the individual 102 from a social interaction. The adaptation of the presented content to the current role 212, as well as the adaptation of the user interface to adjust a level of detail and/or distraction, may be adaptable to suit the current role 212 of the individual 102. Many such variations may be included to suit the particular interaction model of the individual 102 with wearable devices in accordance with the techniques presented herein.

### F. Computing Environment

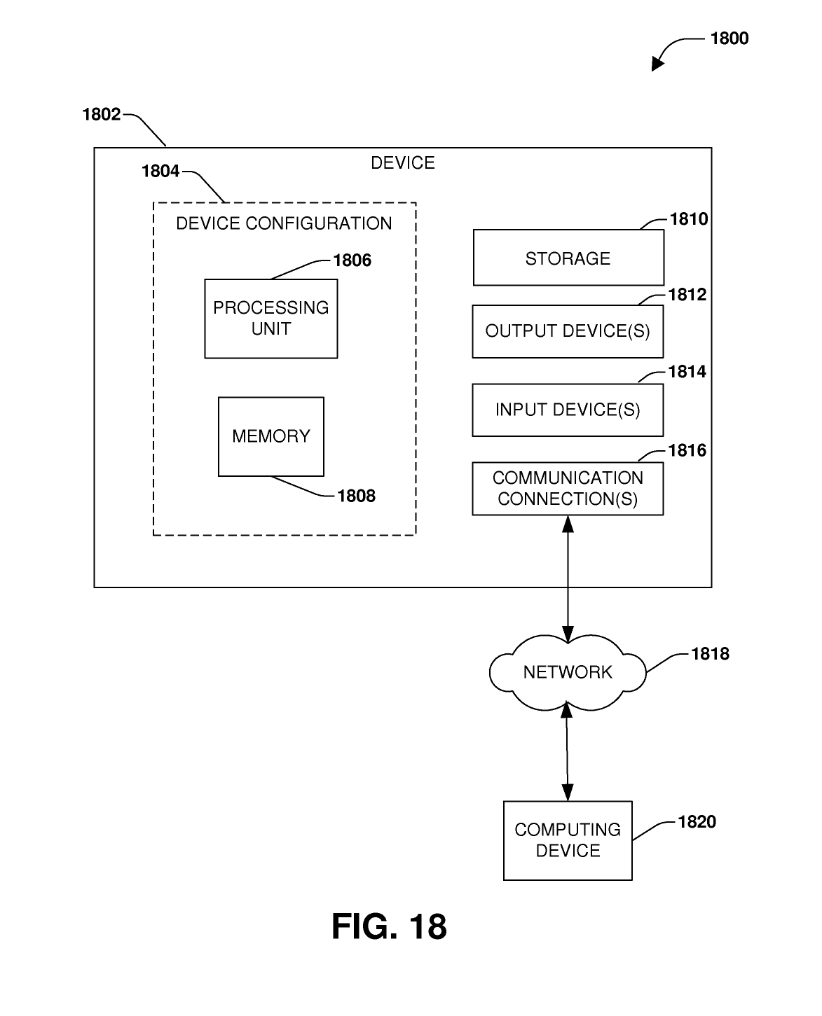

FIG. 18 and the following discussion provide a brief, general description of a suitable computing environment to implement embodiments of one or more of the provisions set forth herein. The operating environment of FIG. 18 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 18 illustrates an example of a system 1800 comprising a computing device 1802 configured to implement one or more embodiments provided herein. In one configuration, computing device 1802 includes at least one processing unit 1806 and memory 1808. Depending on the exact configuration and type of computing device, memory 1808 may be volatile (such as RAM, for example), non-volatile (such as ROM, flash memory, etc., for example) or some combination of the two. This configuration is illustrated in FIG. 18 by dashed line 1804.

In other embodiments, device 1802 may include additional features and/or functionality. For example, device 1802 may also include additional storage (e.g., removable and/or non-removable) including, but not limited to, magnetic storage, optical storage, and the like. Such additional storage is illustrated in FIG. 18 by storage 1810. In one embodiment, computer readable instructions to implement one or more embodiments provided herein may be in storage 1810. Storage 1810 may also store other computer readable instructions to implement an operating system, an application program, and the like. Computer readable instructions may be loaded in memory 1808 for execution by processing unit 1806, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 1808 and storage 1810 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1802 may also include communication connection(s) 1816 that allows device 1802 to communicate with other devices. Communication connection(s) 1816 may include, but is not limited to, a modem, a Network Interface Card (NIC), an integrated network interface, a radio frequency transmitter/receiver, an infrared port, a USB connection, or other interfaces for connecting computing device 1802 to other computing devices. Communication connection(s) 1816 may include a wired connection or a wireless connection. Communication connection(s) 1816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1802 may include input device(s) 1814 such as keyboard, mouse, pen, voice input device, touch input device, infrared cameras, video input devices, and/or any other input device. Output device(s) 1812 such as one or more displays, speakers, printers, and/or any other output device may also be included in device 1802. Input device(s) 1814 and output device(s) 1812 may be connected to device 1802 via a wired connection, wireless connection, or any combination thereof. In one embodiment, an input device or an output device from another computing device may be used as input device(s) 1814 or output device(s) 1812 for computing device 1802.

Components of computing device 1802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1802 may be interconnected by a network. For example, memory 1808 may be comprised of multiple physical memory units located in different physical locations interconnected by a network.

Those skilled in the art will realize that storage devices utilized to store computer readable instructions may be distributed across a network. For example, a computing device 920 accessible via network 1818 may store computer readable instructions to implement one or more embodiments provided herein. Computing device 1802 may access computing device 1820 and download a part or all of the computer readable instructions for execution. Alternatively, computing device 1802 may download pieces of the computer readable instructions, as needed, or some instructions may be executed at computing device 1802 and some at computing device 1820.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A device that exhibits a device behavior while interacting with an individual represented by an individual profile, the device comprising:
a processor; and
a memory storing instructions that, when executed by the processor, provide:
a current role selector that, responsive to detecting a role determinant of the individual, selects, among at least two roles of the individual, a current role that is associated with the role determinant;
a role profile selector that selects, from the individual profile, a current role profile comprising at least one selected individual profile detail that is associated with the current role, and excluding at least one individual profile detail that is not associated with the current role; and
a device behavior adjuster that adjusts the device behavior of the device according to the current role profile of the current role of the individual.

2. The device of claim 1, wherein:
the device further comprises a user interface that enables interaction with the individual according to a user interface property; and
the device behavior adjuster adjusts the device behavior of the device by selecting, among at least two user interface properties, a selected user interface property that is associated with the current role profile of the current role of the individual.

3. The device of claim 1, wherein:
the device further comprises an application set comprising at least two applications that are respectively associated with at least one role; and
the device behavior adjuster adjusts the device behavior of the device by:
identifying, among the at least two applications of the application set:
a first application that is associated with the current role, and
a second application that is not associated with the current role; and
presenting to the individual a current role application set comprising the first application and excluding the second application.

4. The device of claim 1, wherein:
the device further comprises a bookmark set comprising at least two bookmarks respectively associated with at least one role of the individual; and
the device behavior adjuster adjusts the device behavior of the device by:
identifying, among the at least two bookmarks of the bookmark set:
a first bookmark that is associated with the current role, and
a second bookmark that is not associated with the current role; and
presenting to the individual a current role bookmark set comprising the first bookmark and excluding the second bookmark.

5. The device of claim 1, wherein:
the device further comprises at least two actions that are respectively associated with at least one role; and
the device behavior adjuster adjusts the device behavior of the device by:
identifying, among the at least two role determinants:
a first action that is associated with the current role, and
a second action that is not associated with the current role; and
presenting to the individual an action set comprising the first action and excluding the second action.

6. The device of claim 1, wherein:
the device further comprises a contact set comprising at least two contacts respectively associated with at least one role of the individual; and
the device behavior adjuster adjusts the device behavior of the device by:
identifying, among the at least two contacts of the contact set:
a first contact that is associated with the current role, and
a second contact that is not associated with the current role; and
presenting to the individual a current role contact set comprising the first contact and excluding the second contact.

7. The device of claim 1, wherein:
the device further comprises a message set comprising at least two messages respectively associated with at least one role of the individual; and
the device behavior adjuster adjusts the device behavior of the device by:
identifying, among the at least two messages of the message set:
a first message that is associated with the current role, and
a second message that is not associated with the current role; and
presenting to the individual a current role message set comprising the first message and excluding the second message.

8. The device of claim 1, wherein the device behavior adjuster further adjusts the device behavior of the device by:
responsive to receiving a first alert that is associated with the current role of the individual, presenting the first alert to the individual; and
responsive to receiving a second alert that is not associated with the current role of the individual, refraining from presenting the second alert to the individual during selection of the current role of the individual.

9. The device of claim 8, wherein the device behavior adjuster further refrains from presenting the second alert to the individual by:
storing the second alert in association with a second role of the individual; and
responsive to detecting a transition of the individual from the current role to the selected role, presenting the second alert to the individual.

10. The device of claim 8, wherein the device behavior adjuster further refrains from presenting the second alert to the individual by:
determining whether an alert priority of the second alert exceeds an alert priority threshold;
responsive to determining that the alert priority of the second alert exceeds the alert priority threshold, presenting the second alert to the individual during selection of the current role of the individual; and
responsive to determining that the alert priority of the second alert does not exceed the alert priority threshold, refraining from presenting the second alert to the individual during selection of the current role of the individual.

11. The device of claim 1, wherein the device behavior adjuster further adjusts the device behavior of the device by:
responsive to receiving a first content item that is associated with the current role of the individual, presenting the first content item to the individual; and
responsive to receiving a second content item that is not associated with the current role of the individual, refraining from presenting the second content item to the individual during selection of the current role of the individual.

12. The device of claim 1, wherein:
the device further comprises a content item format set comprising at least two content item formats respectively associated with at least one role of the individual; and
the device behavior adjuster further adjusts the device behavior of the device by, responsive to receiving a content item:
identifying, among the content item format set, a selected content item format that is associated with the current role; and
presenting the content item to the individual formatted according to the selected content item format.

13. A server that facilitates a device in interacting with an individual, the server comprising:
a processor;
a transmitter; and
a memory storing:
a role set comprising at least two roles of the individual; and
instructions that, when executed by the processor, provide a system comprising:
a role determinant monitor that receives indicators of at least one role determinant that indicates a selected role of the individual;
a role determinant evaluator that, responsive to the role determinant monitor receiving the at least one role determinant:
compares the at least one role determinant with the at least two roles of the role set to identify the selected role that is indicated by the at least one role determinant, and
stores, in the role set, an association between the selected role of the individual and the at least one role determinant;
a current role selector that, responsive to the role determinant monitor receiving a current role determinant that identifies a current role of the individual, selects, among the at least two roles of the role set, a current role that is associated with the current role determinant that currently describes the individual; and
a device notifier that invokes the transmitter to notify the device of the current role of the individual, to enable the device to adjust a device behavior of an interaction with the individual.

14. The server of claim 13, wherein the role determinant evaluator, before storing the association of the selected role of the individual and the at least one role determinant:
notifies the individual of the at least one role determinant and the selected role of the individual;
presents to the individual an offer to associate the at least one role determinant with the selected role;
responsive to receiving, from the individual, an acceptance of the offer, storing the association between the selected role and the at least one role determinant in the role set; and
responsive to failing to receive the acceptance of the offer from the individual, refraining from storing the association between the selected role and the at least one role determinant in the role set.

15. A method of adjusting a device behavior of a device interacting with an individual represented by an individual profile, the method comprising:
executing, by a processor of the device, instructions that cause the device to, responsive to detecting a role determinant of the individual:
among at least two roles of the individual, select a current role of the individual that is associated with the role determinant;
select, from the individual profile, a current role profile comprising at least one selected individual profile detail that is associated with the current role, and excluding at least one individual profile detail that is not associated with the current role; and
adjust the device behavior of the device according to the current role profile of the current role of the individual.

16. The method of claim 15, wherein:
the device further comprises a trigger that associates a condition with a selected role; and
selecting the current role of the individual further comprises:
monitoring the condition to detect a fulfillment of the condition of the trigger; and
responsive to detecting the fulfillment of the condition of the trigger, selecting the selected role as the current role of the individual.

17. The method of claim 15, wherein the individual profile further comprises a base profile, comprising at least one base individual profile detail that is included in the current role profiles of the respective at least two roles.

18. The method of claim 15, wherein:
a second role of the individual is associated with a second action and with a second role profile comprising a second individual profile detail that is not associated with the current role profile; and
executing the instructions by the processor further causes the device to, responsive to detecting the second action performed by the individual while the individual is associated with the current role:
add the second role to the current role of the individual; and
add the second role profile to the current role profile of the individual.

19. The method of claim 15, wherein executing the instructions by the processor further causes the device to, responsive to detecting a new action performed by the individual that is not associated with any of the at least two roles of the individual:
add to the at least two roles of the individual a new role that is associated with the new action; and
generate, from the individual profile, a new current role profile comprising at least one selected individual profile detail that is associated with the new current role, and excluding at least one individual profile detail that is not associated with the new current role.

20. The method of claim 15, wherein:
executing the instructions by the processor further causes the device to:
present to the individual a role catalog comprising at least one role template for a suggested role of the individual, and
responsive to receiving from the individual a selection of a selected role template:
add the suggested role of the selected role template to the at least two roles of the individual, and
store the selected role template; and
selecting the current role profile further comprises: responsive to selecting the suggested role as the current role, selecting, from the individual profile, the current role profile by applying the selected role template to the individual profile.
